(19) United States
(12) Patent Application Publication
(10) Pub. No.: US 2013/0142975 A1
(43) Pub. Date: Jun. 6, 2013

(54) Barrier Film for Use in Multilayer Thermoformable Materials and Shaped Articles and Containers Made Therefrom

(71) Applicant: Millard F. WALLACE, Orwigsburg, PA (US)

(72) Inventor: Millard F. WALLACE, Orwigsburg, PA (US)

(73) Assignee: Converter Manufacturing, LLC, Orwigsburg, PA (US)

(21) Appl. No.: 13/487,387

(22) Filed: Jun. 4, 2012

Related U.S. Application Data
(60) Provisional application No. 61/492,619, filed on Jun. 2, 2011.

(51) Int. Cl. B32B 1/02; B32B 27/08; B32B 27/30; B32B 27/34; B32B 27/36

(52) U.S. Cl. CPC B32B 1/02; B32B 27/34; B32B 27/36; B32B 27/30; B32B 27/08
USPC 428/36.7; 428/523; 428/474.4; 428/480; 428/475.5; 428/351; 428/339; 428/355 R; 428/189

(57) ABSTRACT

The disclosure relates to a laminated, thermoformable barrier film useful as a peelable surface liner, such as in containers and other shaped articles. The laminated film includes at least two layers, including a distal layer and a medial layer. The medial layer includes an odor-resistant polymer barrier layer that inhibits passage of gases and odors therethrough. The distal layer includes a polymer layer that inhibits permeation of a liquid through to distal layer from a contact face thereof to the barrier layer. Optionally, the distal layer can include a scratch resistant layer. The laminated film can also include a proximal layer that includes a layer of a pliable polymer. The laminated film can be included as a surface liner, or stack of surface liners, on a thermoformed article or on a sheet that can be thermoformed. The laminated sheets have multiple uses, including as liners for food service containers. In such containers, the barrier layer of the laminated sheets can inhibit penetration of the liner by odors or tastes from food items contained therein and can also prevent liquid saturation of the barrier layer of the sheets, which could otherwise limit the odor-resistant properties of the sheets.

### BACKGROUND OF THE DISCLOSURE

This disclosure relates generally to multiple-polymeric-layer thermoformable materials and articles formed from such materials. In particular, the disclosure relates to multilayer polymer films used as thermoformable and/or peelable layers for such materials and articles.

Use of homopolymer films and laminated polymer films to coat food-contacting surfaces is well known in the fields of food preparation, packaging, and storage. Such films are in wide use and many such films are approved by relevant regulatory agencies, such as the Food and Drug Administration in the U.S., for food- and food-preparation-related uses.

One common use of polymer films in the food industry is for packaging of food items in sealed containers. It is recognized in this field that various polymer films exhibit different properties, particularly as they relate to permeability of polymer films to water and gases. In food packaging applications, polymer films having high resistance to permeation by water and oxygen are frequently used in order to prevent drying and oxidation of foods during storage, shipping, and display. In some instances, packaging that exhibits different permeability properties at different times is considered desirable. By way of example, packaging used to sell cuts of meat often is highly impermeable to water and oxygen when it is initially packed. However, because meats develop an unattractive purplish color when stored anoxically, it can be desirable to expose the meat to oxygen prior to offering it for sale. Many in this field have developed meat storage packages (e.g., U.S. Pat. No. 4,886,690) which make use of peelable laminated films, with the laminated film substantially preventing oxygen permeation and the peeled, delaminated film permitting oxygen permeation to restore the packaged meat to a desirable red appearance prior to sale.

Other known food packaging films make use of laminated plastic sheets to form containers, with the layers of the sheets being selected for their favorable properties, such as water- or gas-permeability resistance, rigidity, tear or puncture strength, sealability, and the like. However, the need to seal seams in such sheets (e.g., using heat or adhesives) and the incompatibility of many polymer films can limit the use of desirable polymer films in such containers.

Food Service Containers

Food is commonly held in bins, trays, pans, and other containers during its preparation, presentation, and serving. In order to minimize transmission of food-borne illnesses and to comply with applicable regulations regarding food sanitation, food and food-implement containers must be frequently sanitized. This is particularly true in situations in which food containers are used over long periods, refilled, or accessed frequently by individuals removing items therefrom. Examples of containers of these types include pans used in buffet or steam tables, bins recessed in a food preparation surface, salad bar pans, bulk condiment containers, cutlery bins, hot and cold soup kettles, and chafing dish inserts. In food service settings, it is desirable to maintain hygienic conditions even for containers that do not hold food or implements intended for human consumption (e.g., bins used for busing tables and other utility bins).

Some food service situations require use of many food storage containers to separately contain different food items. Examples of such situations include salad and buffet displays at restaurants, cafeterias, and groceries at which customers select food desired for purchase from the containers. Other examples include food preparation stations (e.g., food preparation tables such as those shown in U.S. Pat. No. 6,385,990) located in restaurant, cafeteria, or grocery settings, at which an employee of the establishment selects food (e.g., sandwich components and condiments) from a variety of trays accessible to the employee in response to requests from a customer. In these settings, containers having standardized sizes are frequently used to facilitate replacement of a used container with a fresh one. Retailer food service practices or government regulations often specify how frequently used containers must be sanitized or replaced, rather than simply refilled with new food items or implements. Frequently, the containers are not refilled, and are instead removed and sanitized prior to being refilled with food and reused, or are simply discarded.

Food storage containers are used to hold foods that must be maintained at cool temperatures (e.g., perishable products such as meats, cheeses, lettuce, tomatoes, and yogurts), foods that are maintained at warm or hot temperatures (e.g., soups or cooked entrees), and food service items that are maintained at ambient temperatures (e.g., breads and crackers, eating utensils, and foods intended for near-immediate consumption). For food storage containers in which heat transfer (either into or from the food contained therein) is desired, it is known to make the containers from materials that exhibit thermal conductivity and heat capacity characteristics suited to the desired use of the container.

Conventional food service containers have a variety of shapes, such as rectangular and circular pans having an open top. A flange or rim typically extends around the perimeter of the open pan top to hold the container in a fitting, such as a frame or rack. When used in a heated or chilled table setting, the flange can also provide a seal around the perimeter of the container, improving energy efficiency (i.e., by preventing loss of heating or cooling medium) and appearance. The flange can also act as a convenient surface for lifting, supporting, and carrying the container. When used in a steam table, buffet table, salad bar, or the like, the body (e.g., the portion containing the food) and flange of a container are typically dimensioned so that the body of the container is received into an opening in the table or bar and is supported by its flange resting upon the edges of the table or bar opening or upon a frame or rack fitted to the bar or table.

Food storage containers sometimes have corresponding lids that are adapted to fit an orifice of the container (e.g., a soup tureen having a fitted lid, optionally with a recessed section to accommodate the handle of a ladle when the tureen and lid are assembled). The lid can serve to exclude contaminants, to prevent gain or loss of heat, or some combination of these functions.

Reusable food service containers of these types are made from a variety of materials, and are frequently made from either metals (e.g., stainless steel) or relatively durable plastics (e.g., polycarbonates). However, disposable food containers made from lower-cost plastics (e.g., various polyethylenes, polyesters, and polypropylenes) are also used.

Regardless of whether reusable or disposable food storage containers are employed, use of the containers typically involves generation of significant quantities of waste. Disposable containers both preclude cost savings that are realized with re-usable containers (since a new container must be used each time) and generate solid waste which must be disposed of properly. Although reusable containers avoid the economic waste of single use containers, they require sanitation procedures that are costly, time consuming, and generate significant quantities of (usually liquid) waste materials. Furthermore, sanitation of reusable food containers tends to generate solid and liquid wastes (e.g., food particles, fats, and greases) that are not soluble in water and for which disposal in wastewater systems tends to be regulated. Thus, commercial scale sanitation of reusable food containers often requires investment in equipment that isolates such wastes (e.g., grease traps), inspections to monitor compliance with applicable regulations, or both. In general, disposal of solid wastes (which are generally removed by truck, rather than by cloggable pipes and sewers) is less regulated and more flexible than disposal of liquid wastes containing non-water-soluble components, in addition to conserving water used for washing.

Others have proposed fitting disposable liners to food service containers in order to alleviate the waste and inconvenience associated with cleaning reusable food service containers. Such liners can be difficult to install and to remove in a sanitary fashion. Also, they are susceptible to bypass if food products from the interior of the liner are spilled or migrate beneath the liner. When such liners are not adapted specifically to the food service container, problems of fitting and use arise from the unmatched dimensions of the liners and containers. For example, non-fitted liners can fold or crease to create pockets in which food products can accumulate or be hidden, leading to spoilage or bacterial growth that can contaminate food products in the remainder of the container. Fitted liners have the drawback that they fit only a specific container, but not others. Inserted liners also have the drawback that they tend to move or slide around in the food service container when foodstuffs are manipulated therein. Furthermore, known liners also have disadvantages stemming from the fact that they are formed (like plastic bags) by welding, adhering, or otherwise sealing plastic sheets along a seam. The seams can often leak or tear, defeating the purpose of the liner. Insertable liners also tend to be relatively unsightly and expensive.

There is a continuing need for a food container that can hygienically contain food and food service items and that can be rapidly and conveniently recycled for multiple uses, preferably without generation of excessive waste materials and while presenting a favorable appearance. In particular, there is a need for containers that can be rapidly and hygienically re-used, without substantial contamination or residue from prior contents. The subject matter of the present disclosure addresses these needs.

### BRIEF SUMMARY OF THE DISCLOSURE

The disclosure relates to a laminated sheet suitable for use as a peelable liner on a thermoformed article for contacting an oily or aqueous liquid. The laminated sheet has a contact face and an adhesion face opposite the contact face and comprises at least medial and distal polymer sheets. The medial sheet comprises a barrier layer of an odor-resistant polymer and has a proximal face and a distal face. The distal sheet includes an anti-permeation polymer layer that substantially inhibits short-term permeation of the liquid therethrough. The distal sheet bears the contact face and has a first face opposite the contact face. The distal sheet also has its first face bound to the distal face of the medial sheet by way of a first tie layer. The contact face has a substantially lower surface energy than the adhesion face. The laminated sheet has flexibility and tensile strength sufficient to enable the laminated sheet to be peeled from a surface to which it is releasibly adhered without tearing.

The disclosure also relates to a formable sheet that includes a sheet of a formable substrate, such as a thermo formable polymer. The formable substrate has a first laminated sheet layered thereon and has a first barrier composition interposed between the formable substrate and the first laminated sheet. The formable sheet can include one or more additional laminated sheet layered on the formable substrate. At least at least a portion of each of the additional laminated sheets overlaps the first laminated sheet and has a second barrier composition interposed between the first laminated sheet and the additional laminated sheet. Shaped articles having a peelable surface can be made by forming (e.g., thermoforming) the formable sheet.

The disclosure further relates to a thermoformable stack. The stack includes a plurality of laminated sheets. Each of the laminated sheets overlaps at least one other laminated sheet and a second barrier composition interposed between overlapping laminated sheets. At least one of the laminated sheets includes a thermoformable polymer layer.

Another form of thermoformable stack described herein includes a thermoformable polymeric substrate. The laminated sheet described herein overlaps the substrate at an overlapping region. A layer of a first barrier composition is interposed between faces of the substrate and the laminated sheet in a portion of the overlapping region and prevents fusion of the surfaces of the substrate and the laminated sheet at the thermoforming condition. When the stack is subjected to the thermoforming condition, the substrate assumes a thermoformed shape and the laminated sheet conforms to that shape at the overlapping region, the substrate and the laminated sheet do not fuse in the portion of the overlapping region, and the laminated sheet can be peeled from the substrate at the portion following thermoforming.

Yet another form of the thermoformable stack described herein includes a thermoformable polymeric substrate and a laminated sheet as described herein overlapping the substrate at an overlapping region. A layer of a first barrier composition is interposed between faces of the substrate and the laminated sheet in a portion of the overlapping region and prevents fusion of the surfaces of the substrate and the laminated sheet at the thermoforming condition. When the stack is subjected to the thermoforming condition, the substrate assumes a thermoformed shape and the laminated sheet conforms to that shape at the overlapping region, the substrate and the laminated sheet do not fuse in the portion of the overlapping region, and the laminated sheet can be peeled from the substrate at the portion following thermoforming.

In another embodiment, this disclosure relates to a container that includes a) a substrate having a shaped side including an interior surface; and b) at least one peelable liner sheet including a bottom sheet. Each liner sheet conforms to the shape of the shaped side, including substantially the entire interior surface, and having an adhesion surface and a contact surface. The adhesion surface of each liner sheet other than the bottom sheet is releasibly adhered to the contact surface of the underlying liner sheet with a peelable adhesive on substantially the entire portion of the adhesion surface that overlaps the interior surface. The adhesion surface of the bottom sheet is releasibly adhered to the shaped side with a peelable adhesive on substantially the entire portion of the bottom sheet that overlaps the interior surface. Each of the liner sheets is a laminated sheet as described herein.

In yet another embodiment, this disclosure relates to a shaped article that includes a shaped thermoformable polymer sheet and a plurality of laminated sheets that overlap the thermoformable sheet at an overlapping region and conform to the shape of the thermoformable sheet at substantially the entire overlapping region. A first barrier composition is interposed between and peelably adheres the thermoformable sheet and the adjacent laminated sheet. A second barrier composition is interposed between and peelably adheres adjacent laminated sheets. The laminated sheets are peelably removable from the article.

### BRIEF DESCRIPTION OF THE DRAWINGS

The figures included herewith are not drawn to scale and are intended to illustrate the subject matter diagrammatically.

FIG. 1 is a cross-section of a laminated sheet 2 composed of a distal sheet 10 and a medial sheet 30 that are bound together by a first tie layer 20. The laminated sheet 2 has a contact layer 1 that is a face of the distal sheet 10 and an adhesion face 3 that is a face of the distal sheet 30. The distal sheet can be composed of multiple materials or multiple regions of the same material, including a scratch-resistant polymer layer 12, an anti-permeation layer 14, and a bonding layer 16. The first face 11 of the distal sheet 10 is bound to the distal face 31 of the medial layer 30 by way of first tie layer 20. The medial sheet can be composed of multiple materials or multiple regions of the same material, including a distal bonding layer 32, a odor barrier layer 34, and a proximal bonding layer 36.

FIG. 2 is a cross-section of another laminated sheet 2, having a construction similar to that shown in FIG. 1, except that the laminated sheet 2 in this figure includes a proximal sheet 50 that is bound to the proximal face 33 of the medial sheet 30 by way of a second tie layer 40. The proximal sheet can be composed of multiple materials or multiple regions of the same material, including a bonding layer 52, a pliable polymer layer 54, and an adhesion layer 56. A barrier composition 60 can be applied to the adhesion face 3 of the laminated sheet 2 in order to modulate interaction of the laminated sheet 2 with a surface against which it rests. By way of example, barrier composition 60 can include an adhesive to promote adhesion of the laminated sheet 2 to the surface or a slip agent to retard adhesion of the laminated sheet 2 to the surface. The laminated sheet 2 can also have a slip composition 70 present at the contact face 1 thereof, to inhibit adhesion of materials to the contact face 1.

FIG. 3 consists of FIGS. 3A, 3B, 3C, and 3D, which are schematic diagrams that illustrate how multiple laminated sheets 2 (designated 2, 2′, 2″, etc.) can be assembled in peelable configurations.

FIG. 3A illustrates a stack of four adhered laminated sheets 2, one of which is adhered to a polymeric substrate 100.

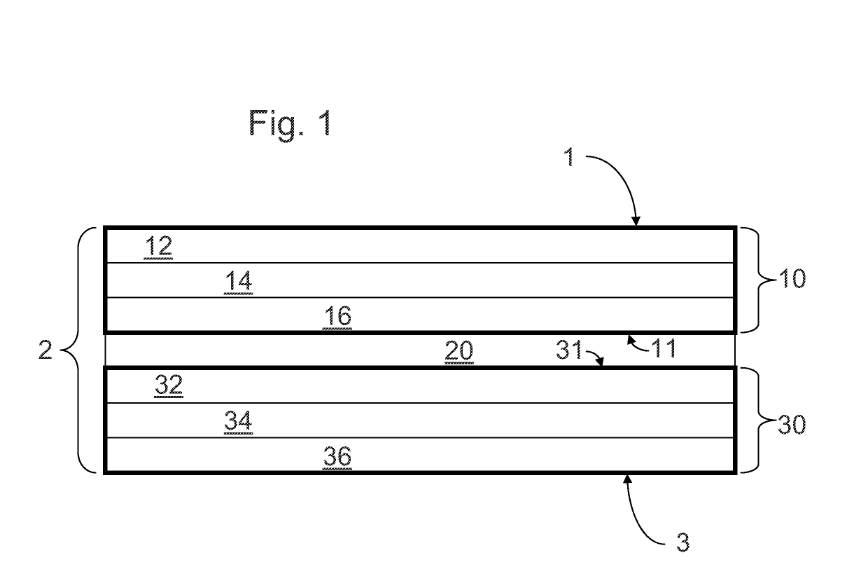

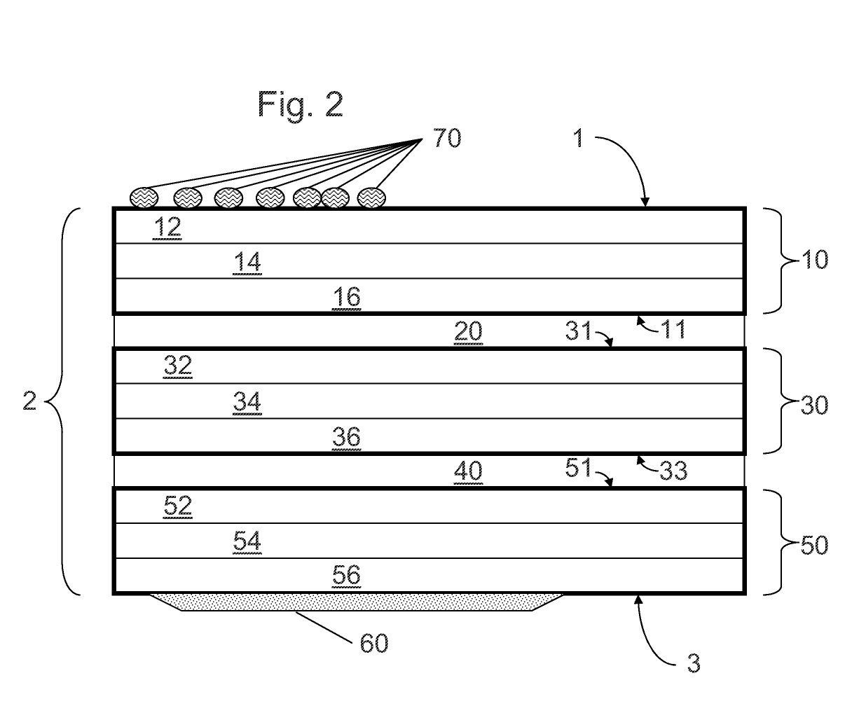

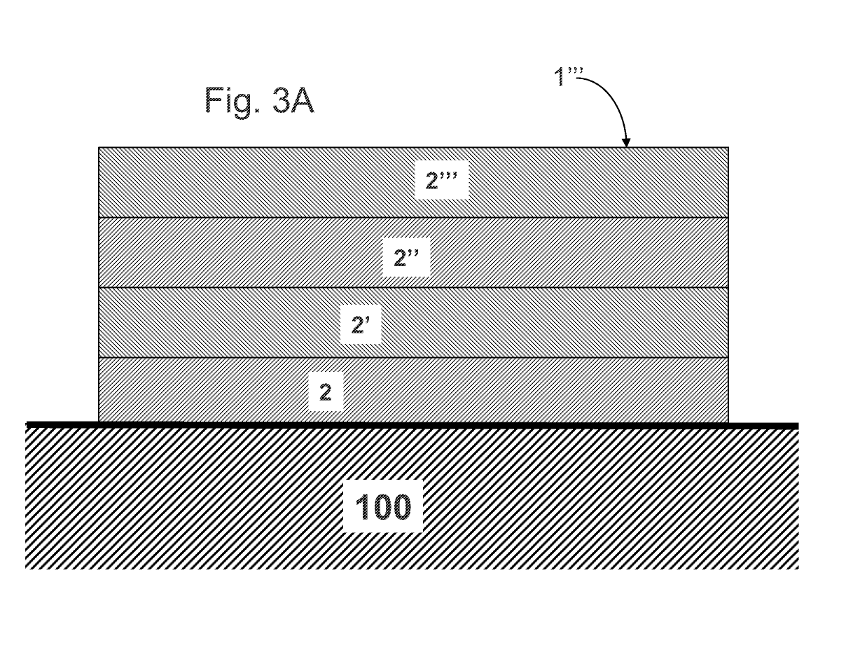

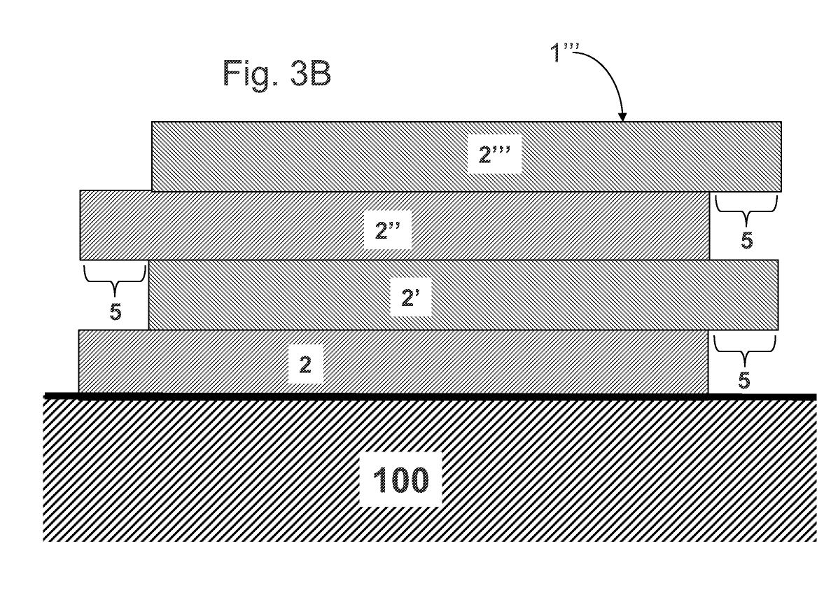

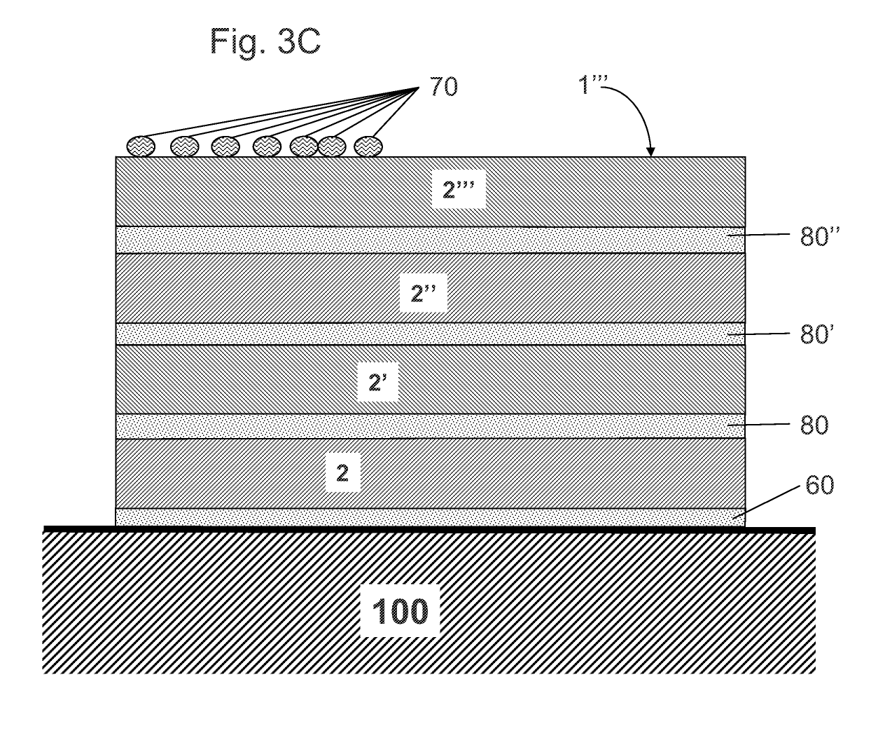

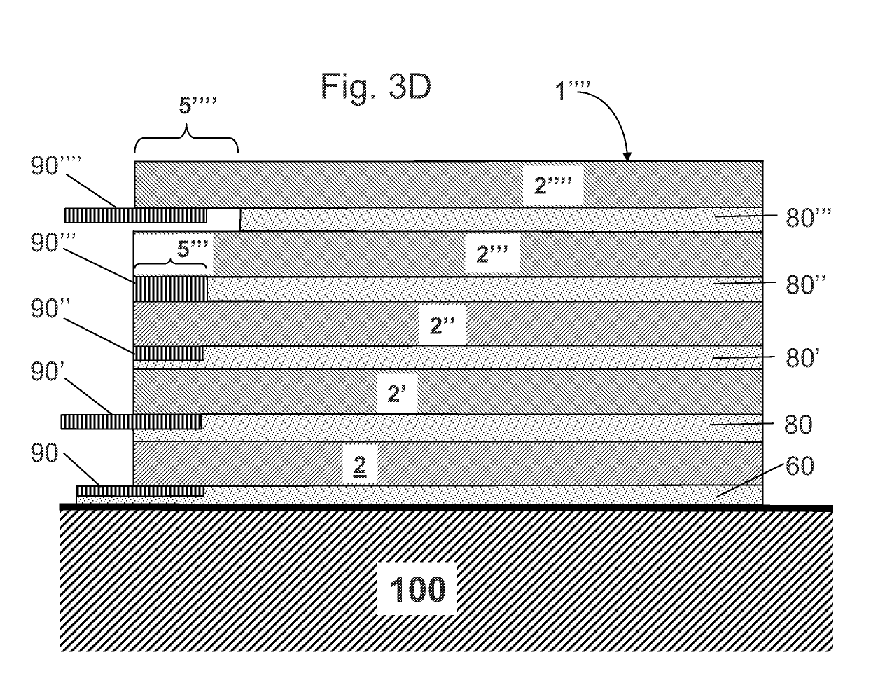

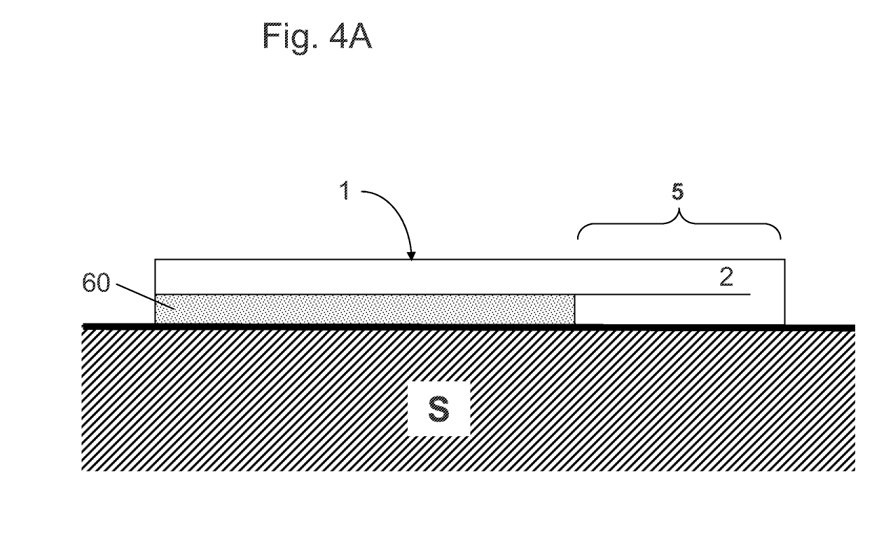

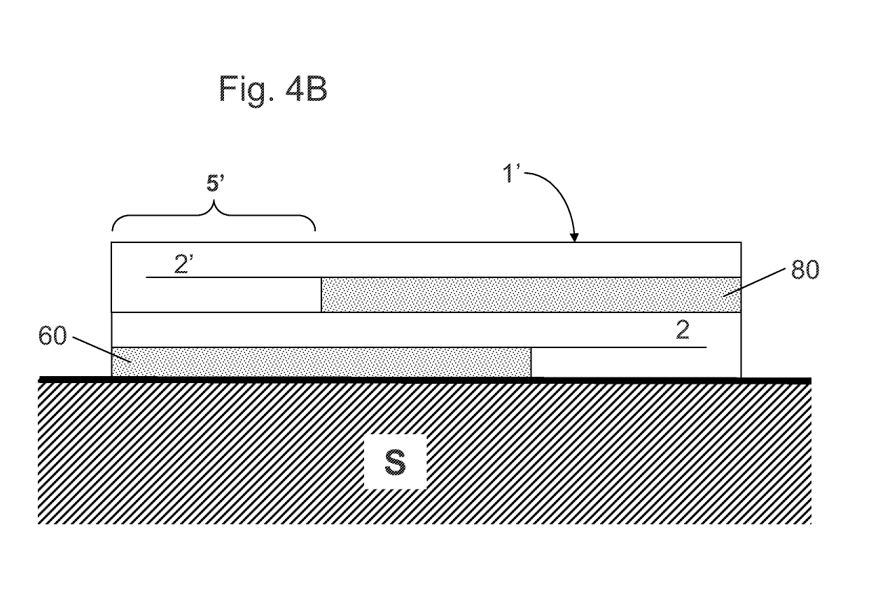

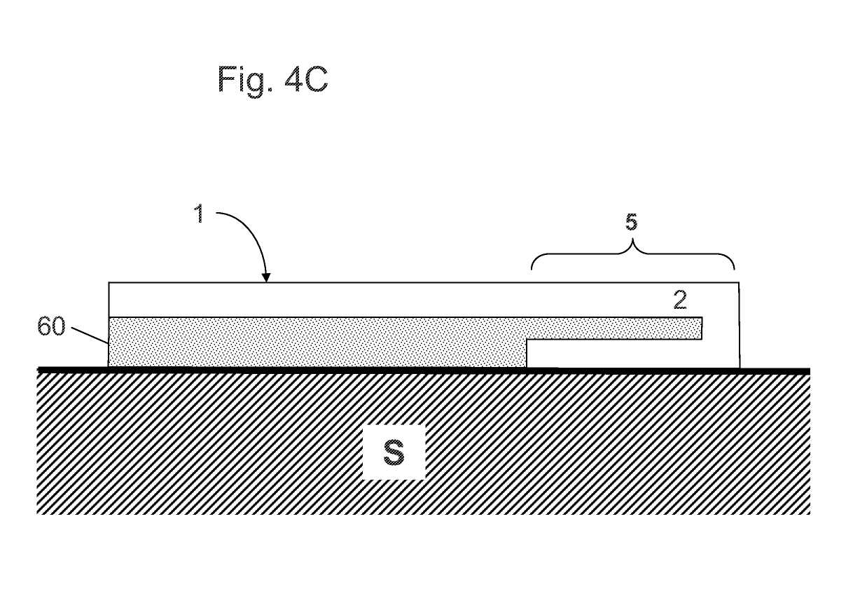

In FIG. 3B, portions at the margins of laminated sheets 2 overhang the margin of the sheet more proximal to the substrate 100, leaving an overhanging portion 5 that is not adhered to the more proximal sheet. These overhanging portions can be used to peel individual laminated sheets 2.

In FIG. 3C, barrier compositions 80 are interposed between adjacent laminated sheets 2 and a barrier composition 60 is interposed between the substrate 100 and the adjacent laminated sheet 2.

In FIG. 3D is shown a stack of laminated sheets 2 having barrier composition 80 therebetween and barrier composition 60 between the substrate 100 and the adjacent laminated sheet 2. A tab 90 is attached to the adhesion face of each laminated sheet 2 to facilitate peeling from the stack of the corresponding laminated sheet 2. A variety of tab configurations are shown. For the laminated sheet 2″″ most distal from the substrate 100, the tab 90″″ extends beyond the margin of the laminated sheet 2″″, is attached to the portion 5″″ that is not adhered to the underlying laminated sheet 2′″, and the tab 90″″ is not adhered to the proximally adjacent laminated sheet 2′″. For the laminated sheet 2′″, the tab 90′″ is flush with the edge of and bonded to the laminated sheet 2′″ and is not adhered to the proximally adjacent laminated sheet 2″. For laminated sheet 2″, tab 90″ is flush with the edge of the laminated sheet 2″, is adhered to the proximally adjacent laminated sheet 2′, but is not adhered to laminated sheet 2″. Tab 90′ is attached to and extends beyond the margin of laminated sheet 2′, and the barrier composition 80 extends to the margin of laminated sheet 2′ and covers a portion of Tab 90′. Tab 90 is adhered over its entire surface to the surface underlying it, which is substrate 100 in this figure, and is attached to laminated sheet 2.

FIG. 4 consists of FIGS. 4A, 4B, and 4C and illustrates ways in which laminated sheets 2 can be folded back upon themselves to form tab-like structures that can be used to facilitate peeling of individual laminated sheets 2 from a surface S to which they are adhesed. In FIG. 4A, a barrier composition 60 that includes an adhesive adheses a laminated sheet 2 to a surface S. A portion 5 of the laminated sheet 2 that is not adhesed to the surface is folded back upon itself and offers a structure that can be grasped and pulled to peel laminated sheet 2 from the surface S. In FIG. 4B, two such laminated sheets 2 are adhesed to the surface S, one atop the other. Upon peeling of laminated sheet 2′, the structure show in FIG. 4A results. FIG. 4C illustrates a variant of the structure shown in FIG. 4A, wherein the adhesive-containing barrier composition 60 is interposed within the overlapping portion 5 of laminated sheet 2. Because the overlapping portion 5 is not adhesed to the surface S, that portion 5 can be grasped and pulled to peel laminated sheet 2 from the surface S.

### DETAILED DESCRIPTION

This disclosure relates generally to multiple-polymer-layer thermoformable materials and articles formed from such materials, such as open-top food service containers (i.e., not sealed pouches or packages). In particular, the disclosure relates to multi-layer (i.e., laminated) polymer films used as peelable and/or thermoformable layers for such materials and articles.

### DEFINITIONS

An “odor-resistant polymer” is a polymer that substantially inhibits migration of a gas therethrough. The ability of a polymer to inhibit migration of a gas therethrough depends on the properties (e.g., chemical nature, thickness and density) of the polymer. These properties can be empirically determined, as is typically done by ordinarily-skilled artisans in this field (e.g., by measuring passage of the gas across a polymer membrane having controlled characteristics under controlled conditions, such as gas concentration and pressure differential across the membrane). By way of example, polyvinyl acetate (PVA) and polyvinyl alcohol (PVOH) polymers are known to exhibit significant gas-barrier properties under a wide range of conditions, and are known to exhibit significantly lower gas-barrier properties under humid conditions or when saturated with water.

A “laminated” sheet is a sheet having multiple, substantially parallel planar layers, without regard to the means of attachment between the layers and without regard to the method by which the layers are assembled or attached. A laminated sheet having multiple layers can be made by coextrusion of the layers to form a single sheet or by adhesion of multiple, separately formed sheets, for example.

A “tie layer” interposed between two polymers sheets is a material which bonds to each of the two sheets and thereby bonds the two sheets together.

Two sheets of material within a laminated sheet 2 are bound “relatively tenaciously” when the force required to separate the two sheets from one another is greater than the force required to peel the laminated sheet 2 from a surface to which the laminated sheet 2 is adhered.

A laminated sheet is “peelable,” as used herein, if the laminated sheet can be peeled from a surface to which it is releasibly adhered by a human of ordinary strength without substantially damaging the surface and without substantially delaminating or tearing the laminated sheet. Put another way, the sheet is “peelable” if it is sufficiently flexible and has sufficient tensile strength that it can be peeled away from the surface without tearing.

A sheet is “adhesed” to an underlying surface if an adhesive that binds both the sheet and the surface is interposed between and contacts both the sheet and the surface, such that the adhesive binds the sheet to the surface. In contrast, a sheet is “adhered” to an underlying surface if the sheet binds the surface, regardless of whether an adhesive is interposed between the sheet and the surface. By way of example, a sheet that binds with an underlying surface in the absence of an interposed adhesive, e.g., owing to the static electrical charges of the sheet and surface, is “adhered” to the surface, but is not “adhesed” to the surface.

A polymer sheet is “releasibly” adhered to a surface if the sheet can be dislodged from the surface (e.g., by peeling) without tearing, delaminating, or breaking the sheet or the surface.

A polymer sheet is “pliable,” as used herein, if the sheet can be substantially deformed (e.g., bent, folded, or crumpled) by application of ordinary human strength without substantially fracturing or tearing the sheet. A pliable polymer sheet preferably is “freely pliable,” meaning that it can be relatively easily deformed by application of minimal human strength, analogously to the pliability of normal writing paper, plastic garbage bags, or plastic grocery bags.

A polymer sheet that contacts an oily or aqueous liquid and has an “anti-permeation” polymer layer is a sheet that includes a polymer layer that substantially inhibits flux of the liquid through the layer. For example, an anti-permeation polymer layer should inhibit flux (i.e., rate of transfer per unit area) of the liquid into a substrate capable of absorbing the liquid by at least 50% when the anti-permeation polymer layer is interposed between and contacts both the liquid and the substrate, relative to the flux when the liquid directly contacts the substrate. Preferably, the flux should be inhibited by at least 90% for the first four hours of liquid-layer-substrate contact. The flux inhibition should endure for at least four, and preferably eight, twelve, twenty-four hours, or longer.

As used herein, the “scratch-resistance” of a polymer sheet or layer is a relative term that depends on the anticipated conditions of use to which the polymer sheet will be exposed. A polymer sheet is “scratch resistant” if it substantially retains its barrier properties (i.e., resistance to permeation by a liquid or a gas) under the peak scratching conditions to which it will normally be exposed in use. By way of example, use of laminated polymer sheets is described herein for providing peelable layers for food service containers in which food items and utensils such as spoons and forks will be inserted. Scratch-resistance in this context means that a polymer sheet that contacts the spoons or forks under ordinary use conditions (e.g., scooping or scraping out food items) will substantially retain (i.e., retain 90% or more of) its barrier properties following such contact.

A polymer is “thermo formable,” as used herein, if the polymer retains a molded shape after being heated to a temperature at which it is relatively pliable, contacted with a mold, and then cooled to a temperature at which it is relatively rigid.

“Polyolefins,” is used herein in its art-accepted sense, meaning polymerized alkenyl compounds, including polyethylene, polypropylene, resinous copolymers of ethylene and propylene, and polymers of ethylene and/or propylene with minor proportions of olefinically unsaturated monomers such as alpha-olefins having from 2 to 8 carbon atoms (e.g., 1-butene, 1-pentene, 1-hexene, 1-heptene, 1-octene and mixed higher alpha-olefins).

“Linear low density polyethylene” (“LLDPE”), is used herein in its art-accepted sense, meaning copolymers of ethylene with one or more comonomers selected from alpha olefins (preferably C-4 to C-10 alpha olefins such as butene-1 or octene) in which the copolymer molecules are in the form of long chains having few side chain branches or cross-links. This structure is in contrast with conventional low density polyethylenes, which are more highly branched than LLDPE. The density of LLDPE is normally in the range of from about 0.916 to about 0.925 grams per cubic centimeter.

“Linear medium density polyethylene” (“LMDPE”), is used herein in its art-accepted sense, meaning copolymers of ethylene with one or more comonomers selected from alpha olefins (preferably C-4 to C-10 alpha olefins such as butene-1 or octene) in which the copolymer molecules are in the form of long chains having few side chain branches or cross-links. This structure is in contrast with conventional medium density polyethylenes, which are more highly branched than LMDPE. The density of LMDPE is normally in the range of from about 0.926 to about 0.941 grams per cubic centimeter.

“Low density polyethylene” (“LDPE”), is used herein in its art-accepted sense, meaning copolymers of ethylene, optionally with one or more comonomers selected from alpha olefins (preferably C-4 to C-10 alpha olefins such as butene-1 or octene) as minor components. This structure is in contrast with conventional medium density polyethylenes, which are more highly branched than LDPE. The density of LDPE is normally in the range of from about 0.910 to about 0.940 grams per cubic centimeter.

“High density polyethylene” (“HDPE”), is used herein in its art-accepted sense, meaning polymers of ethylene, optionally with one or more comonomers selected from alpha olefins (preferably C-4 to C-10 alpha olefins such as butene-1 or octene) as minor components. The density of HDPE is greater than 0.941 grams per cubic centimeter.

“High molecular weight polyethylene” (“HMWPE”), is used herein in its art-accepted sense, meaning polymers of ethylene, optionally with one or more comonomers selected from alpha olefins (preferably C-4 to C-10 alpha olefins such as butene-1 or octene) as minor components. The molecular weight of the polymer chains is typically in the millions, usually between 3 and 6 million.

“Ethylene vinyl acetate” (“EVA”), as used herein, is a known chemical entity and refers to copolymers of ethylene and vinyl acetate monomers. Normally, the ethylene-derived units of the copolymer are present in major amounts, such as between about 60% and 98% by weight and the vinyl acetate derived units in the copolymer are present in minor amounts, such as between about 2% and 40% by weight.

“Ethylene vinyl alcohol” (“EVOH”), as used herein, is a known chemical entity and refers to saponified or hydrolyzed ethylene vinyl acetate polymers, and refers to a vinyl alcohol polymer prepared by, for example, hydrolysis of a vinyl acetate polymer, or by polymerization of polyvinyl alcohol. The degree of hydrolysis should be at least 50% and is more preferably at least 85%. EVOH is normally sued in the form of a copolymer of EVOH and a polyolefin comonomer (e.g., polyethylene). The polyolefin component can, for example, be present in the range of about 15 to about 65 mole percent.

“Polyamides,” is used herein in its art-accepted sense, meaning polymers having amide linkages among the molecular chains. Polyamides include nylons and aramids, for example. The term “polyamides” also includes polyamide copolymers, such as nylon 6 and nylon 12.

“Aromatic polyesters,” is used herein in its art-accepted sense, meaning polymers derived from homopolymers and copolymers of alkyl ester monomers which include an aromatic moiety, such as polyethylene terephthalate (“PET), polybutylene terephthalate, copolymers of isophthalate (e.g., polyethylene terephthalate/isophthalate copolymer), cycloaliphatic esters, and blends of these. Useful PETs include amorphous PET (“APET”), crystalline PET (“CPET”), recycled PET (“RPET”), and glycol-modified PET (“PETG”).

“Polyacrylates,” is used herein in its art-accepted sense, meaning polymers that include linked alkyl acrylate monomers, including copolymers which include different acrylate monomers (including alkyl acrylate monomers, for example) and/or polyolefin monomers. Examples of suitable polyacrylates include ethylene/alkyl acrylate copolymers, ethylene/methyl acrylate copolymers, ethylene/ethyl acrylate copolymers, ethylene/butyl acrylate copolymers, and ethylene/methyl methacrylate copolymers.

“Polyurethanes,” as used herein, refer to polymers having organic monomers with carbamate linkages.

The unit “mil” is used in its art-accepted sense, namely one one-thousandth of an inch in the English measurement system.

### DESCRIPTION

The subject matter of this disclosure relates to a laminated film useful as a peelable layer in articles for which gas- and liquid-barrier properties are desirable. Very crudely simplified, the laminated film includes both a gas-barrier layer and a liquid-barrier layer that prevents contact between the gas-barrier layer and a liquid that the film can be anticipated to contact. By way of example, the laminated film is useful as a peelable liner for containers for storing moist or liquid food items (e.g., meats, cheeses, lettuce, tomatoes, soups, and the like). In such settings, the laminated film not only prevents migration of liquid from one side of the film to the other (as do many conventional plastics), but it also inhibits migration of food tastes or odors from one face of the film to the other (unlike many conventional plastics). The laminated film is made in such a way that it can be adhered to a surface peeled away therefrom without tearing the film or delaminating its various layers.

The disclosure also relates to articles and article precursors (e.g., thermoformable sheets that can be thermoformed to make articles having peelable surface layers) that incorporate the laminated film therein. Stacks of laminated film sheets can also be made, for attachment either to finished articles (e.g., the stack having been thermoformed to conform to an existing surface having a known conformation, such as the interior of a pie pan of known dimensions) or to a formable substrate (e.g., a metal sheet or a planar thermoformable plastic shape).

The Laminated Film

The subject matter of this disclosure relates to a laminated sheet that is suitable for use as a peelable liner on a variety of surfaces. The laminated sheet is capable of withstanding thermoforming conditions, and can therefore be used as a surface coating for thermoformed articles. In some embodiments, the laminated film includes a thermoformable polymer layer and can, itself, be thermoformed, even if it is not attached to a supporting surface. Thermoformable laminated films can be used to coat not only thermoformable substrates, but others as well. Suitable substrates include those that are tolerant of thermoforming conditions but do not require heat for shaping (e.g., thin metal sheets). Substrates intolerant of thermoforming conditions can also be coated using the film, for example by thermoforming the laminated sheet or a stack of such sheets and adhering the sheet/stack to the substrate after the sheet/stack has been thermoformed.

In an important embodiment, the laminated film is used as a surface coating in a food service container. Such containers can contain wet or moist foods, hot or cold liquids, and materials having distinctive tastes or odors. Food service containers are often washed between uses to remove food residues, tastes, and odors, but washing results in large amounts of wasted resources, time, and expense. Drop-in liners are sometimes used to coat the surfaces of food service containers and reduce the need for or frequency of washing, but such liners are difficult to install and handle, can move around during use, and, depending on the materials of which they are constructed and the integrity of their seams, may not prevent migration of food residues, tastes, and odors from one side of the liner to the other. Described herein are laminated films which can be peelably adhered to the food-contacting surfaces of food containers (as well as to surfaces of a variety of other articles) in order to provide a renewable clean surface without the need for washing of the surface.

In one embodiment, the disclosure relates to a laminated sheet that is suitable for use as a peelable liner on a thermoformed article having a surface that contacts an oily or aqueous liquid. The laminated sheet has a contact face (for contacting the liquid) and an adhesion face opposite the contact face. The adhesion face is adhered to an underlying surface (e.g., the surface of the article, a second laminated sheet that is adhered to the article, or the top of a stack of laminated sheets adhered to the article). The laminated sheet includes at least two polymer sheets, referred to herein as the medial and distal polymer sheets, each of which can include multiple sheets or layers. In some embodiments, the laminated sheet also includes a third polymer sheet, referred to herein as the proximal sheet. First is described the embodiment including only the distal and medial sheets.

In this embodiment, the distal sheet lies on the distal (i.e., farther away from the surface of the thermoformed article) side of the medial sheet. The medial sheet includes a barrier layer of an odor-resistant polymer and has a proximal face and a distal face. The distal sheet includes an anti-permeation polymer layer that substantially inhibits short-term permeation of the liquid therethrough. By “short-term” permeation is meant substantial permeation of the liquid during the period of time for which use of the article is anticipated (e.g., 4-12 hours for a food service container containing a food item). The distal sheet has a first face on the side of the distal sheet nearer the medial sheet. The opposite face of the distal sheet is the contact face of the laminated sheet (i.e., the distal-most, relative to the article having the laminated sheets thereon, face of the laminated sheet). The first face of the distal sheet is bound to the distal face of the medial sheet by way of a first tie layer. The contact face of the laminated sheet has a substantially lower surface energy than the adhesion face (i.e., the surface energy of the adhesion face exceeds that of the contact face by 5 Dynes per centimeter or more). Owing to this difference in surface energies, anything interposed between the adhesive face of one laminated sheet (i.e., the more distal face of the medial sheet) and the contact face of an underlying (relative to the surface of the article) laminated sheet will preferentially bind to the adhesive face, so that when the overlying laminated sheet is peeled away, any such interposed thing will preferentially (and preferably substantially completely) be peeled away from the underlying laminated sheet. Thus, if an adhesive is interposed between the two laminated sheets, it will be peeled away with the overlying sheet, leaving the contact face of the underlying sheet relatively (and preferably substantially completely) free of the adhesive.

In order for the laminated sheet to be peelable from the surface underlying it, its flexibility and tensile strength must be sufficient to enable the laminated sheet to be peeled from the surface without tearing. The amount of force required to peel the laminated sheet from the surface will depend, in part, on the characteristics of any substance (e.g., an adhesive, such as a peelable adhesive) that is interposed between the adhesion face of the laminated sheet and the underlying surface. Thus, design of an article having laminated sheets peelable therefrom requires consideration both of the flexibility and tensile strength of the materials in the laminated sheet and of the identity and characteristics of the interposed substance. Furthermore, because the surface energy of the underlying surface can affect how easily any such interposed substance can be peeled from that underlying surface, the peelability of a laminated sheet from that surface can also be affected by controlling the surface energy of the underlying surface. A skilled artisan recognizes that as the tenacity of adhesion between the laminated sheet (and any interposed substance adhered thereto) and the underlying surface increases, so must the minimum tensile strength of the polymer materials used in the layers of the laminated sheet. Similarly, materials having lesser tensile strength can be used where the tenacity of adhesion is lesser.

The flexibility (i.e., bendability and deformability) of the materials used in the layers of the laminated sheet can affect the ease with which the laminated sheet can be peeled from an underlying surface. Although relative stiff, rigid materials having sufficient tensile strength can be peeled from a surface to which they are releasibly adhered, users can experience the peeling of more flexible or stretchy materials as easier and/or more pleasant to achieve. In items having peelable laminated sheet on a surface, as described herein, it is preferred that the peelable sheets be relatively soft and pliable, having a consistency akin to a plastic garbage pail liner or grocery bag, so long as such materials retain sufficient tensile strength to be peeled without tearing or puncturing easily.

In another embodiment of the articles described herein, the laminated sheet includes a proximal sheet in addition to the distal and medial sheets already described. In this embodiment, the proximal sheet is bound to the proximal face of the medial sheet by a second face of the proximal sheet, and the opposite face of the proximal sheet acts as the adhesion face of the laminated sheet. A second tie layer (which may be made as the same material as the first tie layer or of a different material) bonds the proximal sheet to the medial sheet.

The proximal sheet preferably contains a layer of a pliable polymer, to contribute to the flexibility and/or tensile strength of the laminated sheet. Because relatively thin layers (e.g., 0.25 mil or thinner) of polymers can be used for the barrier and anti-permeation layers (and because the medial and distal sheets, respectively, need include no other layers or materials than these), the combined thickness of the distal, the medial sheet, and the interposed first tie layer can be very small (e.g., 0.5 mil or smaller). This is advantageous, in that these materials can be relatively expensive. However, such thinness can adversely affect the tensile strength of the laminated sheet. Because the proximal sheet need not exhibit properties of either the barrier layer or the anti-permeation layer, less expensive materials can be used. Thus, in some embodiments, the proximal layer is made of a relatively strong but inexpensive polymer (e.g., a polyolefin such as polypropylene) and forms the bulk of the laminated sheet (e.g., 50%, 75%, or 90% or more, by weight), and relatively thin distal and medial sheets and first and second tie layers make up the remainder. Thin sheets (e.g., 1-2 mils thick) are generally preferred. However, thicker sheets (not thicker than about 8 mils) can still be peelable.

An important property of the materials used to make the various polymer sheets and layers of the laminated sheet is that the materials do not substantially shrink at conditions under which the laminated sheet will be stored, transported, or used. By “substantially shrink” is meant shrinkage of more than 5% by length in any direction. A special case is presented if all materials shrink at substantially the same rate at substantially the same temperatures, but that is an unusual situation and not expected to be used often. This is in contrast to the properties normally sought in packaging films and the polymers used therein, for which heat-facilitated shrinkage is desirable for conforming the shape of the films to the contours of the item being packaged. For this reason, the polymer sheets and layers used in the laminated sheet are preferably not oriented in any direction and preferably do not substantially shrink under normal use and storage conditions. Oriented films that exhibit only minimal (i.e., 5% or less) shrink under thermoforming conditions can be used.

By way of example, for laminated sheets that will normally be maintained at ambient temperatures typical of human environments (i.e., not hotter than about 100 degrees Fahrenheit), materials that exhibit less than 5% shrink at a temperature as high as 125 degrees Fahrenheit are preferable. As another example, laminated sheets that may be contacted with boiling water (ca. 212 degrees Fahrenheit) should be made using materials that exhibit less than 5% shrink at a temperature as high as 250 degrees Fahrenheit. Further by way of example, materials that exhibit less than 5% shrink at a temperature as high as 500 degrees Fahrenheit should be used to make laminated sheets (e.g., liners for baking pans) that may be used in contact with foodstuffs during baking operations.

Use of polymers that resist permeation by liquids and other polymers that resist permeation by gases are known. It is also known that performance of gas-permeation-resistant polymers can be degraded by absorption of aqueous or oily liquids into the polymer matrix. Others have laminated gas-resistant polymer films between liquid-resistant polymer films to protect the gas-resistant properties of the laminated film. Such laminated films have been used, for example, in food storage packages. However, such packages are inevitably used as closed, sealed packages (i.e., to protect food by providing the gas- and liquid-resistant features on all sides of the stored food). It is believed that such laminated films have not previously been employed as described herein—as peelable liners for open-top containers.

The laminated sheets described herein can inhibit migration of liquids and gases (including tastes and odors) between the contact surfaces of laminated sheets arranged in a peelable stack. For instance, if a conventional, non-peelable food service container were used to store pickles, then the taste and odor of pickles would be transferred to another food item (e.g., mayonnaise, a mild-tasting cheese, or hard-boiled eggs subsequently stored in the same container unless the container were thoroughly washed between such storage. However, if the container were lined with a laminated sheet as described herein, the taste and odor of pickles stored in the container prior to peeling the sheet from the surface of the container would not cross the laminated sheet, and the container could be used for storing other food items without the need to wash the container.

The efficacy of the laminated sheets described herein derives from the combination of the liquid barrier property provided by the anti-permeation layer of the distal sheet and the odor/gas barrier property provided by the barrier layer of the medial sheet. By shielding the barrier layer from the potentially performance-detrimenting effects of liquids contacting the contact face of the laminated sheet, the anti-permeation layer enhances the performance of the peelable laminated sheet. Thus, for example, a PVOH barrier layer is highly effective to inhibit gas and odor permeation, unless it becomes moist. By pairing an anti-permeation layer (e.g., one including a hydrophobic polymer) that inhibits flux of aqueous liquids from the contact face to the barrier layer with an odor-resistant polymer at the barrier layer, the ability of the laminated sheet to inhibit transmission of liquids, tastes, and odors is enhanced. Similarly, a hydrophilic anti-permeation layer that resists permeation by oily liquids can be paired with an odor-resistant polymer for which odor-resisting behavior is detrimented by absorption of oily liquids to yield an effective taste and odor shielding laminated sheet.

The compositions and dimensions of the distal sheet and the tie layer can be selected such that, following application of the liquid to the contact face at a pressure of six inches of the liquid for four hours (or twelve hours, or some other selected time period), the concentration of the liquid in the barrier layer is less than 50% of the saturated concentration of the liquid in the odor-resistant polymer. By modifying those compositions and dimensions, greater exclusion of liquid from the odor-resistant polymer can be achieved. Such design is routine in this area and can be achieved with minimal or no empirical testing.

The multiple layers and sheets of the laminated sheets described herein provide opportunities for controlling the appearance of the laminated sheets. In one embodiment, at least one component of the laminated sheet (e.g., at least one of the distal sheet and the medial sheet) is substantially opaque. The color of one or more of the components can be selected to yield a desired appearance as well. Similarly, substantially transparent laminated sheets can be obtained by use of transparent materials and processes which combine those materials in ways that maintain clarity and transparency.

An image (e.g., a letter or word, a diagram, a pattern, a color, or some combination of these) can be printed on one or more surfaces of the sheets and layers of the laminated sheets. So long as any sheets or layers interposed between the printed image and the intended location of the viewer are transparent (or at least translucent), the viewer will be able to see the image. By way of example, if an image is to be viewed while a laminated sheet remains adhered to an object, the image can be printed on the contact face of the laminated sheet. In instances (e.g., on food service containers) in which contact between printed images and materials which contact the contact face of the laminated sheet is undesirable, the image can be viewed if it is printed on a surface within the laminated sheet (e.g., the distal face of the medial sheet) and the contact face and any materials between the contact face and the surface on which the printing occurs are transparent or translucent. Similarly, if an image is intended to be viewable only after a laminated sheet is peeled from a surface to which it was previously adhered, the contact layer can be opaque, and the image can be printed on the adhesion face of the laminated sheet, or on another layer, so long as the adhesion face and all materials between the adhesion face and the layer on which the printing appears are transparent or translucent.

Laminated films thicker than about 8 mils can be difficult to peel from a surface. For that reason, the thickness of the laminated film described herein is preferably not greater than 8 mils. There is no lower limit on the thickness of the laminated film, other than that it should be sufficiently thick, in view of its tensile strength, that it can be peeled from a surface to which it is releasibly adhered without tearing. As this minimum tensile strength is necessarily a function of the adhesive used to adhese the laminated sheet to the surface, the minimal thickness of the sheet will depend on the identity of the adhesive and the materials used in the construction of the laminated sheet.

In the context of the foregoing general overview, properties of components of the laminated sheet are described in the ensuing sections.

The Medial Sheet

The laminated sheet includes a medial sheet that includes (or consists of) a barrier layer. The barrier layer includes (or consists of) an odor-resistant polymer layer of a type and having a thickness sufficient to inhibit or prevent migration of volatile molecules (i.e., gases) therethrough.

Numerous odor-resistant polymers are known, as are the particular types of gases for which permeation through such polymers can be inhibited. Substantially any known odor-resistant polymer can be used in the laminated sheets and articles described herein, at least in view of the information provided herein. Resistance of a layer of a polymer to permeation by a gas is known to be a function of the thickness of the polymer layer and a diffusion coefficient specific for the gas/polymer combination. The values of the diffusion coefficient is known for numerous gas/polymer combinations. In the case of polymer/gas combinations not previously studied or reported by others, the diffusion coefficient and diffusional behavior can be empirically determined by routine methods.

With knowledge of the identity(ies) of the gas for which permeation through the barrier layer is to be inhibited, an appropriate odor-resistant polymer and barrier layer thickness can be selected. If sufficient gas-barrier properties are not provided by a single polymer layer of reasonable thickness, a plurality of layers of different odor-resistant polymers can be used to form the barrier layer of the medial sheet. Preferably, however, the barrier layer, and in fact the entire medial sheet, is a single homopolymeric sheet.

In the laminated sheet described herein, the medial sheet has a distal face that is bound to the distal sheet at the first face of the distal sheet by way of a first tie layer. Some odor-resistant polymers can be tied directly to a polymer included at the first face of the distal sheet. In laminated sheets that include such odor-resistant polymers as the barrier layer (or at least as the distal-most layer of the barrier layer), the barrier layer can be located at the distal face of the medial sheet and bonded directly to the first layer of the distal sheet.

In one embodiment, the distal sheet is a homo layer of an anti-permeation polymer, the medial sheet is a homo layer of the odor-resistant polymer, and the distal and medial sheets are each directly bound by a first tie layer that tenaciously binds with both polymers (e.g., an adhesive that binds with each of the polymers, a bi-functional chemical agent that covalently binds each of the polymers and links them together, or a boundary layer in which the polymers bind with one another covalently, ionically, by hydrogen bonding, by van der Waals forces, or otherwise). Such a three-layer structure (homopolymer-distal-sheet/homogenous-tie-layer/homopolymer-medial-sheet) is the simplest of the laminated sheets disclosed herein and compose as few as two materials (i.e., polymers capable of binding one another). Such laminated films can also compose three materials (i.e., two polymers and a tie layer compound capable of binding both polymers).

Odor-resistant polymers that cannot be tied directly to the bonding layer of the distal sheet or to a first tie layer compound can nonetheless be used in the laminated sheets described herein if they are included in a medial sheet having a distal bonding layer that is capable of adhering relatively tenaciously with the bonding layer of the distal sheet and/or with the first tie layer. Such a distal bonding layer can be included in the medial sheet in several ways.

A distal bonding layer can be added to the barrier layer of a medial sheet by adhering a discrete polymer sheet to the barrier layer (or to one or more other interposed sheets adhered to the barrier layer). Such adherence can be achieved in any known way including, for example, by fusing or adhesing a discrete polymer layer to the barrier layer. Regardless of the means used to achieve it, adherence of the distal bonding layer to the barrier layer should result in adherence that is relatively tenacious, so that the distal bonding layer will not delaminate from the barrier layer upon peeling of the laminated sheet 2 from a surface to which it is adhered. The material used in the distal bonding layer should be selected to facilitate relatively tenacious binding between the distal and medial sheets.

A distal bonding layer can also be added to the barrier layer of a medial sheet by physical or chemical modification of an otherwise homogenous layer of the odor-resistant polymer. Suitable physical modifications for facilitating bonding between the odor-resistant polymer and either the first tie layer or the bonding layer of the distal sheet are well known and include, for example, polishing, buffing, corona treatment, and the like. Chemical modifications for facilitating such bonding include reactions with any chemical agent that render the odor-resistant polymer able to bond (chemically, ionically, by dipole interactions, etc. with either the first tie layer or the bonding layer of the distal sheet. Innumerable chemical modifications are known in the art and readily selected and performed by skilled artisans in this field, depending on the identities of the materials involved.

In laminated sheets 2 that include a proximal sheet bound to the proximal face of the medial sheet, the medial sheet can likewise include a proximal bonding layer to facilitate tying the barrier layer to the proximal sheet.

In laminated sheets 2 that do not include a proximal sheet, the proximal face of the medial sheet can be the adhesive face of the laminated sheet. In such a sheet, the medial sheet can include a proximal bonding layer that facilitates relatively tenacious adhesion between the barrier layer and any adhesive applied to the proximal face of the medial sheet (i.e., an adhesive used to adhese the laminated sheet 2 to an underlying surface). As with the distal bonding layer, the proximal bonding layer can be a layer of a polymer different from the odor-resistant polymer, or it can be a physically- or chemically-modified layer of the odor-resistant polymer.

The identity of the odor-resistant polymer is not critical, but is preferably one of the polymer materials known to exhibit high gas impermeability. When the identity of the gas for which a barrier function is desired (e.g., acetic acid and other volatile organic compounds for pickles) is known, the odor-resistant polymer can be specifically selected for its known barrier properties for gases of that type. (Of course, the abilities of polymers to exhibit a barrier function for such gases can be empirically tested as well, and such testing will frequently be done to select among different grades and manufacturers of a selected polymer material).

By way of example, suitable odor-resistant polymers include polyvinyl acetates (PVAs), polyvinyl alcohols (PVOHs), co-polymers of PVAs and polyolefins, co-polymers of PVOHs and polyolefins, polyamides, polyvinyl chlorides (PVCs), polyvinylidene chlorides (PVDCs), aromatic polyesters, and combinations of these (i.e., co-polymers of these and, where possible, solid phases in which two or more of these polymers occur). Some preferred odor-resistant polymers are co-polymers of a PVA and a polyolefin selected from the group consisting of polyethylenes, polypropylenes, polybutylenes, and combinations of these. Other preferred odor-resistant polymers are co-polymers of a PVOH and a polyolefin selected from the group consisting of polyethylenes, polypropylenes, polybutylenes, and combinations of these. If the odor-resistant polymer is a polyamide, it can be one selected from the group consisting of nylons, aramids, and combinations of these. Among the aromatic polyesters, polyethylene terephthalate (PET) is a preferred material, including biaxially-oriented PET (boPET) in either metalized (e.g., aluminized) or non-metalized form.

The thickness of the barrier layer is not critical, other than that it should be sufficiently thick to substantially inhibit (i.e., reduce by 50% or more) passage therethrough of a volatile molecule of interest (e.g., a component of a food taste or odor) for a period commensurate with the anticipated duration of use of the article on which the laminated sheet is adhered. For instance, in the context of a food service container lined with a stack of the laminated sheet described herein and used for a sandwich assembly station to hold pickles, peeling of a laminated sheet about every four to eight hours can be expected. Thus, for that situation, the barrier layer should be sufficiently thick to substantially prevent migration of pickle odor and taste from one side of a laminated sheet to the other for that period.

Owing to the cost or rigidity of odor-resistant polymers, it can be advantageous to minimize the thickness of the barrier layer. Sufficient thickness and tensile strength can be imparted to the laminated sheet by other components such as the distal sheet or, when present, the proximal sheet.

The Distal Sheet

The distal sheet performs a liquid barrier function, separating the barrier layer of the medial sheet from liquid that contacts the contact face of the laminated sheet. The distal sheet includes an anti-permeation polymer layer that substantially inhibits permeation of an oily or aqueous liquid from the contact fact to the barrier layer. The distal sheet can also include other layers or sheets, including a scratch-resistant layer, a bonding layer (for facilitating bonding to the medial sheet), or both. These layers or sheets can be discrete materials bonded to one another to form the distal sheet. Alternatively, these layers or sheets can be formed by physical or chemical treatment of a homogenous (prior to treatment) polymer sheet to form layers or regions within the sheet that have the desired properties.

The anti-permeation layer inhibits flux of the liquid into the barrier layer by at least 50%, relative to flux of the liquid into the same barrier layer in direct contact with the liquid. Preferably, the anti-permeation layer inhibits substantially all (i.e., >95%) of flux of the liquid during the expected duration of use of the article (e.g., four to eight hours for a food service container having the laminated sheet coating the food-contacting surface) that includes the laminated sheet (e.g., four to eight hours for a food service container having the laminated sheet coating the food-contacting surface).

The chemical identity of the anti-permeation polymer is not critical and will depend on the identity and nature (i.e., aqueous or oily) of the fluid to be excluded. A wide variety of polymers that inhibit permeation of fluids are known. A skilled artisan in this field can select a polymer having known liquid-permeation-inhibiting properties or assess the permeation-inhibiting properties of polymers using routine techniques.

Some odor-resistant polymers are known to be hygroscopic and to absorb water when put into contact with it. When a hygroscopic odor-resistant polymer is used in the barrier layer of the medial sheet, the anti-permeation layer of the distal sheet should include an anti-permeation layer that inhibits flux of aqueous fluids therethrough. Examples of suitable anti-permeation polymers include aromatic polyesters, polyolefins, polyamides, PVCs, PVDCs, polyacrylates, polyurethanes, and combinations of these (i.e., co-polymers of these and, where possible, solid phases in which two or more of these polymers occur). For applications in which the contact layer is anticipated to contact foodstuffs or food items intended for human consumption, preferred anti-permeation polymers include aromatic polyesters, polyolefins, polyamides, and combinations of these. PET is considered a preferable aromatic polyester.

The distal sheet preferably also performs a scratch-resistance function as well, and includes a scratch-resistant polymer layer at the contact face of the laminated sheet. The barrier layer of the medial sheet performs an important gas-barrier function, but this function can be degraded if the barrier layer is breached or abraded. Furthermore, the anti-permeation layer of the distal sheet has an important role in shielding the barrier layer from liquid that may degrade performance of the barrier layer. Breach, abrasion, or damage to the anti-permeation layer can also degrade performance of the laminated sheet. By including a scratch-resistant layer distal to at least the barrier layer and preferably distal to or coextensive with the anti-permeation layer, performance of the laminated sheet can be improved, particularly in environments where scratching, scraping, abrasion, or rubbing of the laminated sheet can be expected during ordinary use of the article to which it is adhered.

A wide variety of abrasion-resistant polymers are known, and substantially any of these can be used as the scratch-resistant polymer layer, including aromatic polyesters (e.g., PETs), polyacrylates, polyamides (especially nylons), polyurethanes, boPETs, and combinations of these.

Scratch-resistance can be imparted to the distal sheet by selection of a highly abrasion-resistant polymer, by physical or chemical surface treatment of a polymer, or by some combination of these.

The precise degree of scratch-resistance provided by the scratch-resistant polymer layer depends on the conditions incident to the intended use of the article having the laminated sheet on its surface. The scratch-resistance should be sufficient to preserve the gas-barrier function of the odor-resistant polymer and the liquid-barrier function of the anti-permeation layer throughout the expected duration of use of the article to the surface of which the laminated sheet is adhered. The thickness of the scratch-resistant layer and degree of abrasion-resistance required can be, and preferably is, determined empirically under the desired conditions of use or as close a simulation as can be made.

When the scratch-resistant layer is not the same polymer layer as the anti-permeation layer, the scratch-resistant layer is preferably located distal to (i.e., further from the medial sheet and further from any surface to which the laminated sheet is adhered) the anti-permeation layer of the distal sheet, so as to impart the protection afforded by its scratch-resistance to both the anti-permeation layer and the barrier layer of the medial sheet. By way of example, a laminated sheet can have a distal sheet composed of a relatively thick nylon scratch-resistant layer tenaciously adhered to a relatively thin PET anti-water-permeation layer, with the PET layer adhered by way of a tie layer to a medial sheet that consists of a relatively thin PVOH/polyethylene copolymer barrier layer. The nylon layer imparts both scratch-resistance and relatively high tensile strength to the laminated sheet.

In a preferred embodiment, a polymer that exhibits both the desired anti-permeation properties and the desired scratch-resistant properties is used. By way of example, a laminated sheet can have a distal sheet consisting of a relatively thick PET layer that acts as both an anti-water-permeation layer and a scratch-resistant layer, with the PET layer adhered by way of a tie layer to a medial sheet that consists of a relatively thin PVOH/polyethylene copolymer barrier layer. The PET layer imparts scratch-resistance, resistance to water permeation, and relatively high tensile strength to the laminated sheet. The PVOH copolymer layer imparts significant resistance to gas permeation.

The First Tie Layer

The first tie layer relatively tenaciously adheres the distal sheet and the medial sheet, meaning that these two sheet require greater force to delaminate than the force required to peel the laminated sheet from a surface to which it is adhered. The tenacity of adhesion of the laminated sheet to the surface can vary depending on the chemical identities of the materials present at the adhesion face of the laminated sheet and the surface and the presence, absence, and properties of any adhesive interposed between the adhesion face of the laminated sheet and the surface. Accordingly, the required tenacity of adhesion between the distal and medial sheets can vary, depending on those factors. Preferably, the tenacity of adhesion between the distal and medial sheets is far greater (10×, 100×, or greater) than the tenacity of adhesion of the laminated sheet to the surface.

The identity and nature of the first tie layer can vary, depending on the identity and nature of the distal and medial sheets, and particularly the bonding layer of the distal sheet and the distal bonding layer of the medial sheet (if different than the bulk of the corresponding distal and medial sheets).

The identity of the agent(s) used as the first tie layer is not critical, so long as the tie layer performs the distal sheet-to-medial sheet bonding function.

By way of example, the first tie layer may be an adhesive (e.g., a BYNEL brand adhesive resin made by E.I. DuPont de Nemours and Company) that adhesively binds the first face of the distal sheet and the distal face of the medial sheet. Alternatively, the tie layer can be a polymer formed from a resin that binds with one or both of the first face of the distal sheet and the distal face of the medial sheet.

By way of example, if the distal sheet includes a nylon material at its first face and the medial sheet includes an EVOH polymer at its distal face, an anhydride-modified polyolefin resin (e.g., PLEXAR brand resins sold by LyondellBasell of Rotterdam, Netherlands) will bind covalently with each face and form a polymeric tie layer which tenaciously binds each face. Similarly, compounds (e.g., substituted polysaccharides and polyolefin resins) that are bi- or multi-functional and capable of binding with each face can covalently (and tenaciously) link the distal and medial sheets.

By way of further example, the first tie layer may consist of a layer of material formed by interaction of the distal and medial sheets (or at least by the bonding layer of the distal sheet and the distal bonding layer of the medial sheet). Such interactions may be covalent, ionic, hydrogen bonding, van der Waals interactions, or non-characterized interactions, so long as the adhesive tenacity between the distal and medial sheets excludes the adhesive tenacity between the laminated sheet and any surface to which it is adhered. In instances in which the contacting polymer layers of the distal and medial sheets are made from polymer materials that are capable of mingling in the melted state (i.e., polymers having similar surface energies in the molten state, such as LDPE and EVA), the first tie layer can consist of a layer of entangled chains of the polymers of the contacting polymer layers. When distal and medial sheets are to be connected by a first tie layer that includes intermingled polymer chains of the two sheets, the polymers at the contacting faces of the sheets are preferably selected such that the at least one of the intermingled polymers forms discrete crystallized regions when admixed with the other polymer.

The first tie layer may be applied to one or both of the distal and medial sheets in a form that does not tenaciously adhere the two initially, but does so after the first tie layer has been exposed to heat, such as during a thermoforming step. This arrangement permits minor positional shifts between the distal and medial sheets during the heat exposure step, and can alleviate internal stresses that might otherwise occur were the two layers tenaciously adhered prior to heat setting of the tie layer.

The foregoing examples of appropriate first tie layer materials are not exhaustive. A skilled artisan appreciates that substantially any material that tenaciously binds the distal and medial sheets together can be used. Such materials must not adversely affect the required properties of the laminated sheet (e.g., flexibility and peelability), and they preferably do not adversely affect other desired properties, such as color, optical clarity, smell, taste, and substantial lack of temperature-dependent shrinkage.

The Proximal Sheet

As described above, the laminated sheet described herein can include only a distal sheet and a medial sheet linked by a first tie layer. The gas-barrier function provided by the medial sheet and the liquid-barrier (and scratch-resistance, if elected) function(s) provided by the distal sheet can often be provided by very thin (e.g., 0.5 mil, 0.1 mil, or thinner) layers of polymers. However, because the laminated sheet must have sufficient tensile strength and flexibility that it can be peeled from a surface, thicker films (generally at least 0.5 mil, and preferably 0.5-2 mils) can be required than would otherwise satisfy these barrier functions. Many polymers that exhibit gas- and/or liquid-barrier functions are more costly than other commonly available polymers, such as simple polyolefins, that lack robust barrier functionality. Furthermore, selecting gas- and liquid-barrier polymers that exhibit the required flexibility and tensile strength required of the laminated sheet can severely limit the number and type of polymer materials that can be used (or even render such selection effectively impossible).

While the gas- and liquid-barrier properties of the laminated sheet are provided by the medial and distal sheets, it is not necessary that the flexibility and tensile strength requirements of the laminated sheet be provided by the polymers of those same sheets. Instead, one or more additional sheets can be included in the laminated sheet to impart to the laminated sheet the required flexibility and tensile strength. When such additional sheet(s) are included, the medial and distal sheets (or, at least the polymers of the barrier layer of the medial sheet and the anti-permeation layer of the distal sheet) need not exhibit the flexibility and tensile strength required of the laminated sheet, so long as all of the layers of material in the laminated sheet, taken together, exhibit those required properties.

One or more additional sheets or layers imparting bulk, flexibility, and/or tensile strength to the laminated sheet can be included with the distal sheet, with the medial sheet, or with both of these. If included with the distal sheet, the additional sheet or layer is preferably added proximal to the scratch-resistance layer of the distal sheet if the distal sheet includes a scratch-resistance layer, so that the scratch- and abrasion-resistance of that layer can protect the additional sheet or layer in addition to the other parts of the laminated sheet. Such additional material, when added to the distal sheet, is also preferably included distal to the anti-permeation layer, so long as the flexibility and/or tensile strength of the additional material is not degraded by the liquid excluded by the anti-permeation layer, in which case the anti-permeation layer should be situated distally relative to the additional material (i.e., so as to inhibit permeation of the liquid into the additional material). When such additional sheets or layers are included in the medial sheet, it is not critical where, within the medial sheet, they are situated. However, if the additional materials in the medial sheet are situated distally relative to the barrier layer, the additional material may provide scratch- or abrasion-resistance (or at least a buffer of scratchable and abradable material) to the barrier layer. Techniques for including additional polymeric layers or sheets in another polymer sheet or stack of sheets are known, and substantially any such techniques can be used.

In a preferred embodiment, the laminated sheet includes a proximal sheet in addition to the distal sheet and the medial sheet. The proximal sheet is situated proximally (relative to the relatively distal contact face of the laminated sheet) with respect to the medial sheet and has a second face that is bound to the proximal face of the medial sheet by way of a second tie layer. The proximal layer includes a pliable polymer layer that contributes flexibility and/or tensile strength to the laminated sheet.

The proximal sheet may also impart a liquid barrier function to the laminated sheet at the adhesion face thereof. Although the proximal face of the medial sheet is typically shielded from liquid contacting the contact face of the laminated sheet by the anti-permeation layer (and the other layers, if present) of the distal sheet, small amounts of liquid may be carried around the ends of the laminated sheet. For example, PVOH in a barrier layer of a laminated sheet can absorb ambient moisture during long term storage, owing to diffusion of atmospheric water vapor between the laminated sheet and a surface to which it is applied or by ‘wicking’ of an aqueous liquid drawn by surface tension between the closely spaced adhesion face of the laminated sheet and the surface. If a proximal sheet that exhibits liquid-barrier properties (not necessarily as effective a liquid barrier as the anti-permeation layer of the distal sheet) is tenaciously adhered to the proximal face of the medial sheet, then the liquid-barrier properties of the proximal sheet will be imparted to the proximal face of the medial sheet, thereby providing liquid-barrier protection to the barrier layer of the medial sheet. Such protection can reduce liquid uptake by the barrier layer of the medial sheet attributable to spills, environmental exposure, or other sources, thereby enhancing the gas-barrier properties of the odor-resistant polymer.

The material(s) used to make the proximal sheet are not critical. Where the proximal sheet is intended primarily to provide bulk, flexibility, and/or tensile strength to a laminated sheet, the choice of material(s) will often be driven by concerns such as the cost of the material and its compatibility with the other portions (primarily the medial sheet and the second tie layer) of the laminated sheet. In one embodiment, relatively expensive polymers that exhibit superior liquid- and gas-barrier properties, but which do not necessarily exhibit the flexibility and tensile strength requirements of the laminated sheet, are used as the anti-permeation layer and barrier layer of the distal and medial sheets, respectively. In this embodiment, the anti-permeation layer and barrier layer are relatively thin (<1 mil each), and the proximal sheet includes a pliable polymer layer that is substantially thicker (e.g., ca. 2 mils). By way of example, such an embodiment would consist of a 0.5 mil-thick layer of PET as the distal sheet, bound by a very thin (<ca. 0.1 mil thick) layer of a DuPont BYNEL adhesive to a medial sheet consisting of a 0.2-mil-thick layer of PVOH/polyethylene copolymer, with the medial sheet being melt bonded (i.e., contacted in a molten state during coextrusion, such that the contacted molten layers bond during cooling) with a proximal pliable polyethylene layer having a thickness of 2 mils.

Appropriate polymers to use in a pliable polymer layer are known and their identity is not critical. Suitable materials include polyolefins (polyethylenes, polypropylenes, and combinations of these), aromatic polyesters, polyacrylates, polyurethanes, and combinations of these. As with the other polymer sheets of the laminated sheet, the proximal sheet preferably does not include any oriented polymer, so that the proximal sheet does not shrink in one or more dimensions upon heating. In instances in which the proximal sheet provides the bulk of the tensile strength of the laminated sheet, heat-induced shrinkage of one of the polymer sheets (e.g., the odor-resistant polymer of the barrier layer of the medial sheet) tenaciously adhered to the proximal sheet can be tolerated so long as the tension created by such shrinkage at a selected temperature is significantly (i.e., at least ten-fold) lower than the tensile strength of the proximal sheet at the selected temperature. Preferably, however, none of the polymers of the laminated sheet exhibits substantial temperature-related shrink.

The thickness of the proximal sheet is not critical and can be driven by such concerns as the cost of the materials used to make it, the ease of making or processing the proximal sheet, its ability to be thermoset, its appearance, and the barrier function provided thereby. Where a thermoformable laminated sheet is desired, the proximal sheet can include or consist of a thermoformable polymer layer, such that the proximal sheet retains its shape following thermoforming.

The Second Tie Layer

Analogous to the first tie layer described herein, the second tie layer relatively tenaciously adheres the proximal sheet and the medial sheet, meaning that these two sheet require greater force to delaminate than the force required to peel the laminated sheet from a surface to which it is adhered. The tenacity of adhesion of the laminated sheet to the surface can vary depending on the chemical identities of the materials present at the adhesion face of the laminated sheet and the surface and the presence, absence, and properties of any adhesive interposed between the adhesion face of the laminated sheet and the surface. Accordingly, the required tenacity of adhesion between the proximal and medial sheets can vary, depending on those factors. Preferably, the tenacity of adhesion between the proximal and medial sheets is far greater (10×, 100×, or greater) than the tenacity of adhesion of the laminated sheet to the surface.

Like those of the first tie layer, the identity and nature of the second tie layer can vary, depending on the identity and nature of the proximal and medial sheets, and particularly the bonding layer of the proximal sheet and the proximal bonding layer of the medial sheet (if different than the bulk of the corresponding proximal and medial sheets).

The identity of the agent(s) used as the second tie layer is not critical, so long as the second tie layer performs the proximal sheet-to-medial sheet bonding function.

The same examples provided herein in connection with the first tie layer exemplify appropriate second tie layer materials. Suitable second tie layer materials include, for example, adhesives, resins that bind with one or both of the second face of the proximal sheet and the proximal face of the medial sheet, compounds (e.g., substituted polysaccharides and polyolefin resins) that are bi- or multi-functional and capable of binding with each face can covalently (and tenaciously) link the proximal and medial sheets, and layers of material formed by interaction of the proximal and medial sheets (or at least by the bonding layer of the proximal sheet and the proximal bonding layer of the medial sheet).

The foregoing examples of appropriate second tie layer materials are not exhaustive. A skilled artisan appreciates that substantially any material that tenaciously binds the proximal and medial sheets together can be used. Such materials must not adversely affect the required properties of the laminated sheet (e.g., flexibility and peelability), and they preferably do not adversely affect other desired properties, such as color, optical clarity, smell, taste, and substantial lack of temperature-dependent shrinkage.

Manufacture of Laminated Sheets

The laminated sheets can be made by substantially any sheet-forming process. By way of example, laminated sheets can be made by blowing, molding, casting, or extruding suitable polymer materials, or by some combination of these processes. The individual polymer sheets (i.e., the distal, medial and, when present, proximal sheets) can be formed separately and combined to form the laminated sheet. Alternatively, the multiple sheets that make up the laminated sheet can be formed simultaneously, such as by co-extrusion. Co-extrusion is particularly suitable when the first and/or second tie layer of the laminated sheet consists of heat-bonded, melt-bonded, or chain-entangled portions of adjacent polymer layers. Coextrusion of such polymer layers can be used to contact the layers in a hot or melted form, facilitating such bonding. When they include a thermoformable material (as one or more layers preferably does), the laminated sheets can be thermoformed simultaneously with shaping of a substrate (e.g., a sheet of thermoformable material or a sheet of metal formed by stamping) to which they are adhered. When made of non-thermo formable materials, the peelable sheets should be capable of maintaining their structural integrity at the conditions at which any substrate sheet to which they are adhered is formed.

Stacks of Laminated Sheets

In an important embodiment, the laminated sheets described herein are arranged in the conformation of a stack of laminated sheets, whereby the contact face of one “lower” laminated sheet (in the context of a stack being assembled from a low to a high position, with the adhesion face of the lower stack facing the lower direction) is arranged beneath the adhesion face of an “upper” laminated sheet. The stack thus made includes two laminated sheets (preferably substantially aligned at their edges), with the adhesion face of the lower sheet being the adhesion face of the stack and the contact face of the upper sheet being the contact face of the stack. Onto the stack thus constructed can be added additional laminated sheets in the same orientation, with the contact face of the uppermost sheet being the contact face of the stack and the adhesion face of the lowermost sheet being the adhesion face of the stack.

In an important embodiment, at least one, and preferably each laminated sheet in a stack is thermoformable (i.e., the sheet includes a thermoformable material therein). The stack includes a first laminated sheet that includes a thermoformable polymer and at least a second laminated sheet that overlaps the first laminated sheet at an overlapping region. The first and second laminated sheets can have the same composition and thickness, or these characteristics can be different. The stack can include multiple second laminated sheets (made of the same or different polymers and having the same or different thicknesses). The stack can also include sheets of other materials, such as metal foil sheets or an uppermost layer of simpler construction (e.g., a thermoformable homopolymer sheet). A layer of a first barrier composition is interposed between faces of the first and second laminated sheets in at least a portion of the overlapping region. The first barrier composition prevents fusion of the surfaces of the first and second sheets at the thermoforming condition. When the stack is subjected to the thermoforming condition, the first laminated sheet assumes a thermoformed shape, the shape of the second laminated sheet conforms to the shape of the first laminated sheet, and the first and second laminated sheets do not fuse in the portion of the overlapping region.

In order to prevent detachment or deformation of the second laminated sheet away from the first laminated sheet after thermoforming, the first barrier composition can include an adhesive that peelably adheres the first and second laminated sheets. By incorporating such an adhesive into the first barrier composition, thermoformed articles can be made in which the second laminated sheet can be peeled away from the first laminated sheet, preferably (i.e., by judicious selection of an adhesive) without tearing either of the first and second laminated sheets. All, or only a portion, of the overlapping region can be coated with the adhesive-containing first barrier composition. When a tab is interposed between laminated sheets, the tab can be adhered to the adhesive and used to pull the edge of the laminated sheet to which the tab is adhered away from the adjacent laminated sheet to which the tab is not adhered. In alternative configurations, the adhesive can be incorporated into the barrier composition or the adhesive can be a composition discrete from the barrier compositions. By way of example, a barrier composition having perforations or holes therethrough can be interposed between laminated sheets and a separate adhesive interposed between the sheets on one side of the barrier composition (i.e., the adhesive contacting both sheets through the holes or perforations).

An important embodiment of the subject matter disclosed herein is a stack (sometimes referred to herein as a “master pad roll” when provided in the form of a rolled stack) of overlapping laminated sheets, optionally adhered to a substrate layer. This stack can include a substrate, for example a thermoformable polymer sheet, a plurality (e.g., 2, 3, 6, 10, or 20) of laminated sheets. Each laminated sheet overlaps the first sheet or the substrate at the overlapping region and has a layer of a second barrier composition interposed between it and each adjacent laminated sheet in a portion of the overlapping region. The first barrier composition prevents fusion of the surfaces of the first sheet and the adjacent laminated sheet or surface at the thermoforming condition. The second barrier composition (which may be identical to the first) prevents fusion of the surfaces of adjacent laminated sheets at the thermoforming condition. When the stack is subjected to the thermoforming condition, the first sheet assumes a thermoformed shape, the shape of each of the laminated sheets conforms to the shape of the first sheet, and the sheets do not fuse in the portion of the overlapping region. In this embodiment, each of the laminated sheets can have different, identical, or substantially the same composition.

In one embodiment, an article having a relatively thick (e.g., 10 to 40 mils) substrate layer made from a thermoformed polymer can have multiple thin (e.g., 1 to 7 mils) laminated sheets that are separately, peelably adhered to the substrate. The substrate can provide shape and rigidity to the article (e.g., a paint tray or a food service container), and the peelable laminated sheets can provide a renewably clean surface upon peeling of individual sheets.

The stack described herein can be prepared and provided in the form of multi-sheet leaves, folded bundles, or rolls, for example. In many polymer-processing operations, rolls of polymeric materials are preferred for ease of handling. Rolls of the stack described herein can be prepared simply by winding the stack about itself, or about a core such as a paper or wooden tube or cylinder, in a rotary fashion. In order to minimize unintended interactions between the bottom of the stack in one layer of the roll and the top of the stack in an adjacent layer of the roll, a slip composition or release agent can be interposed between layers of stack as it is rolled. In one embodiment, the slip composition is a sheet of a material such as paper or waxed paper. In another embodiment, the slip composition is an oil or other liquid agent which inhibits or prevents irreversible interaction of stack layers. By way of example, a thin film of a silicone-based compound (e.g., a liquid polysiloxane-containing composition, such as a silicone oil) can be applied to the top, bottom, or both top and bottom of the stack as it is rolled. The slip composition should either be an agent which does not affect thermoforming operations on the stack or an agent which can be separated from the stack prior to thermoforming operations.

Substrates, Including Formable and Thermoformable Substrates

The laminated sheets described herein can be adhered, individually or in stacks, to a variety of surfaces and peeled therefrom. A first barrier composition can be interposed between a surface of a substrate and a laminated sheet adhered thereto. The first barrier composition can prevent fusion of the sheet and the surface, for example, when the substrate and the sheet are shaped (e.g., thermoformed) at the same time. When a stack of laminated sheets is adhered to a surface, a second barrier composition (which can be the same as or different from the first) can be interposed between the sheets to prevent fusion among sheets. In fact a different barrier composition can be used between each pair of sheets, if desired. The barrier compositions can, and preferably do, include an adhesive such that the laminated sheets can be peeled (individual, if adhered in a stack) from the surface.

In an important embodiment, the substrate to which the laminated sheet(s) are adhered is a thermoformable polymer sheet. When the laminated sheet described herein (or a stack of such laminated sheets) is adhered to a thermoformable polymer sheet, the thermoformable polymer sheet and the laminated sheet(s) can be thermoformed together to form an article having a desired configuration (e.g., a food service container having peelable surface layers).

The identity and composition of thermoformable polymer sheets used in the articles and methods described herein are not critical. A skilled artisan will recognize that substantially any thermo formable polymeric material can be used. Examples of suitable thermoformable polymeric materials include polyethylene terephthalates, polyesters, polyethylenes (e.g., high density polyethylenes and high molecular weight polyethylenes), polypropylenes, polyvinylchlorides, polystyrenes, nylons, copolymers of these, and combinations of these. Plant-based polymers, such as polylactates (also known as “lactic acid polymers” and PLAs) can also be used.

A skilled artisan can select a thermoformable polymeric material, or combinations of such materials, suitable for use in substantially any application by considering such properties as the shrink rate, crystallinity, heat deflection temperature, tear strength, draw ratio, thickness, rigidity, melt temperature, thermal conductivity, and polymer backbone orientation of the materials. Selection of materials can also be guided by properties that do not necessarily directly impact the thermformability of the materials, such as cost, color, opacity, recycled material content, environmental impact, surface energy, chemical resistance, and surface sheen of the materials.

In selecting appropriate materials, an artisan should consider at least two sets of conditions: the environmental conditions to which the finished, shaped article will be subjected and the conditions that the materials will experience during the thermoforming process. Materials should be selected so as to exhibit the desired color, shape, strength, rigidity, and peelability, for example, once the materials have been shaped in the thermoforming process into their final, desired form. The materials should also be selected, together with the thermoforming conditions, so as to allow assembly and shaping of the materials into their final, desired form using thermoforming conditions available to the artisan.

Thermoforming is not the only mechanism by which the substrate and/or the laminated sheets can be shaped. The laminated sheets can be adhered to a substrate shaped in substantially any way and remain peelable so long as the laminated sheets are not obstructed, clamped, cut (at least to the extent that they lose their physical integrity in the portion for which peelability is desired), or otherwise physically restricted from a peeling conformation. Examples of other shaping techniques include stamping, bending, inflating, and the like. It is immaterial whether the laminated sheets are shaped prior to adhering them to a pre-shaped surface or whether the laminated sheets and the surface are shaped simultaneously (although closer fit can be achieved in the latter instance).

Tabs Between Stacked Laminated Sheets

One or more tabs can be interposed between the laminated sheets and/or between the proximal-most laminated sheet in a stack and a surface to which that sheet is adhered. If a tab extends beyond an edge of a laminated sheet, the tab can be used to facilitate separation of the more-proximal and more-distal laminated sheets after thermoforming. The tab can be adhered to either sheet or to neither.

In one embodiment, the tab is relatively fixedly adhered to the lower surface of a laminated sheet that overlies another laminated sheet or another surface. The tab is either peelably adhered to or not adhered to the underlying laminated sheet (or surface), such that the overlying laminated sheet can be peeled from the underlying laminated sheet (or surface) by grasping the tab and pulling the overlying sheet by way of the tab.

In a second embodiment, the tab is relatively fixedly adhered to the underlying sheet (or to the surface) and either peelably adhered to or not adhered to the overlying laminated sheet, such that the overlying laminated sheet can be peeled from the underlying laminated sheet (or surface) by scratching (e.g., with a fingernail or an edged instrument, such as the tine of a fork) the edge of the overlying laminated sheet that overlies the tab to begin partial peeling of the overlying laminated sheet at the location of the tab, and then grasping the partially peeled portion of the overlying laminated sheet and manually peeling the remainder of the overlying laminated sheet away from the underlying laminated sheet (or surface) by pulling on the partially peeled portion. In this second embodiment, if the overlying laminated sheet is peelably adhered to the tab (i.e., rather than not adhered at all to the tab), then adhesion of the overlying laminated sheet to the tab can exclude materials (e.g., dust or liquids) from the space between the tab and overlying laminated sheet, rendering the tab surface clean upon peeling the overlying laminated sheet therefrom.

In another useful embodiment, no tab is incorporated beneath a sheet, and instead, there is printing, a color difference (between the laminated sheet and the underlying sheet or substrate), or some other indicium that identifies the edge of the laminated sheet. By aid of this indicium, a user can discern the edge of the peelable laminated sheet and can begin peeling it, e.g., by inserting a thin item (e.g., a card) beneath the edge or by scratching at the edge with a relatively sharp instrument, such as a fingernail. In yet another useful embodiment, the tab is not a material discrete from the laminated sheet, but is instead a part of that laminated sheet. By way of example, the part can be a portion of the laminated sheet that extends away from the remainder of the laminated sheet at an edge thereof and that is not adhered to the underlying surface (see, e.g., FIG. 3B, portions 5). Further by way of example, the part can be an edge of the sheet (or a portion that extends from the edge) that is folded back beneath the laminated sheet (e.g., all or part of one edge of the sheet can be folded under itself in a strip about ¼ inch wide; see FIG. 4). If the folded-back edge (or portion) lies atop adhesive on top of the underlying surface, then the folded-back edge (or portion) will “balloon” out away from the underlying surface when the edge is scratched, rubbed, or displaced, facilitating grasping and peeling of the peelable sheet. If, the laminated sheet has adhesive on its underside prior to folding back the edge or portion thereof, then the overlapping layers of the tab will adhere to one another, but not to the underlying surface (See FIG. 4C), yielding a graspable tab that can be easily accessed from above the tabbed, laminated sheet.

Barrier Compositions

The identity and composition of barrier compositions interposed between polymer sheets used in the articles and methods described herein are not critical. A skilled artisan will recognize that substantially any material can be used as a barrier composition between two polymers, so long as it substantially prevents fusion of two polymers under conditions at which at least one of the polymers can be thermoformed. A wide variety of such barrier compositions are known for this purpose.

Examples of suitable barrier compositions include adhesives (e.g., peelable adhesives such as pressure-sensitive adhesives), known polymer release agents, a polymeric or paper film interposed between polymer layers, and various liquids, including low-viscosity silicone oils.

A composition interposed between two surfaces (e.g., between the first and second polymer sheets, or between two second polymer sheets, as described herein) can act as a barrier composition between the two surfaces if the composition coats at least one of the two surfaces at a thermoforming condition, thereby preventing surface-to-surface contact and fusion of the two surfaces at the thermoforming condition.

A barrier composition prevents fusion of opposed polymeric surfaces only when it is interposed between the surfaces at the thermoforming condition. For that reason, the barrier composition must be interposed between the surfaces over the entire area for which fusion between the surfaces is not desired. This can be achieved in various ways, including use of liquid and solid barrier compositions. When a stack is to be thermoformed to make a plurality of shaped objects that are not fused over some portions, but fused at least one portion (e.g., a stack of cookie trays fused only at a single, frangible extension of the trays at one corner), the barrier composition is interposed among the polymer sheets in the non-fused areas, but is not interposed between the polymer sheets in the area in which fusion is desired.

Liquid barrier compositions should be selected such that they completely coat (i.e., wet) at least one of the surfaces over the entire area for which fusion is not desired. This can be achieved by selecting a liquid barrier composition (i.e., a composition that is a liquid at least the thermoforming condition, regardless of whether it is a liquid at which it is contacted with the surface) that has a surface tension significantly greater (i.e., at least 2 Dynes per centimeter, and preferably at least 10 Dynes per centimeter greater) than the surface energy of the surface with which it is contacted. This surface energy difference should ensure that the liquid barrier composition completely wets (i.e., coats) the area of the surface for which fusion is not desired. Preferably, the liquid barrier composition has a surface tension significantly greater than the surface energy of both surfaces, so that the liquid is not displaced from between the surfaces at points at which the two surfaces are urged tightly against one another.

Solid barrier compositions (e.g., polymer sheets) should be selected so that the solid covers the entire area for which fusion is not desired. The identity of the solid is not critical, so long as it does not prevent the portions of a polymer sheet that are to be thermoformed from reaching the thermoforming condition. Solid barrier compositions can prevent fusion of the surfaces (and/or) fail to fuse to one or both surfaces for a variety of reasons, any of which are sufficient to render a material suitable as a solid barrier composition. Some solids can be predicted to act as suitable barrier compositions, while other may require empirical testing (e.g., thermoforming two sheets of the polymer with the solid interposed between them) in order to determine their suitability. Either way, selection of an appropriate solid barrier composition is within the ken of a skilled artisan in this field.

Another type of barrier composition that can be used is a composition incorporated as an additive into one or both of the polymer sheets. These compositions melt and “bloom” to the surface of a polymer when heated, pressed, stretched, or otherwise manipulated. If such a composition is included in one or both of the polymer sheets such that the composition blooms at the surface of at least one sheet at the thermoforming condition and prevents contact between the polymer sheets themselves, then the composition can be used as a barrier composition in the articles and methods described herein. A wide variety of compositions that exhibit such blooming behavior are known in the art.

Adhesives

The peelable nature of an individual laminated sheet can derive from surface attraction between the laminated sheet and the surface underlying it. Preferably, however, an adhesive is interposed between the sheet and the surface and the peelable nature of the sheet derives primarily from the adhesive forces exerted by the adhesive upon the laminated sheet and the surface. An adhesive can be selected (e.g., based on the chemical identity or the surface treatment of the peelable sheet or the surface to which it is adhered) so that, upon peeling of the laminated sheet, the adhesive preferentially remains adhered to the laminated sheet, or to the surface. For instance, when the function of the laminated sheet is to expose the surface free of adhesive and other contaminants, the adhesive can be selected so that it both adheres the laminated sheet and the surface, but adheres more strongly (i.e., more tenaciously) to the adhesion face of the laminated sheet so that, upon peeling, the adhesive is removed from the surface along with the laminated sheet.

The identity and composition of adhesive interposed between polymer sheets used in the articles and methods described herein are not critical. A skilled artisan will recognize that substantially any material can be used as an adhesive between two polymers, so long as it reversibly binds the two polymer layers and requires no more force to separate the polymer layers than can be practically applied to the polymer layers by a person of ordinary strength. A wide variety of such compositions are known for this purpose.

The adhesives used between a peelable polymer sheet and an underlying surface are preferably peelable, meaning that the polymer sheet can be peeled from the surface by a person of ordinary strength, preferably without tearing or substantially stretching the sheet. Preferably, an adhesive having a coat weight of roughly 0.6 to 15 ounces per inch is used to adhere a peelable sheet to an underlying surface.

A wide variety of suitable adhesives are known in the art and can be used as described herein. Pressure-sensitive adhesives are among the suitable adhesives that can be used. Likewise, adhesives that adhere preferentially to one of two adhered surfaces, upon peeling of one of the surfaces away from the other) are suitable and are preferred in certain embodiments. By way of example, if an adhesive adheres more strongly to a peelable polymer sheet than to a surface to which the sheet is adhered by the adhesive, the adhesive will tend to remain with the sheet when it is peeled from the surface.

Various compounds and surface treatments can be used to reduce the force needed to pull an adhesive from a surface, and such compounds and treatments can be used to modulate adhesion of an adhesive to a surface described herein.

Specific examples of adhesives that can be used in the articles described herein include polysiloxane-based adhesives, rubber cement, and acrylic adhesives (e.g., waterborne pressure-sensitive, acrylic adhesives of the MULTI-LOK brand family of acrylic adhesives manufactured by National Adhesives of Bridgewater, N.J.).

Differences in the tenacity with which an adhesive binds the opposed surfaces of two polymer sheets can be controlled in a number of ways, including by coating one or more portions of one surface with a composition that inhibits binding of the adhesive to the surface. Preferably, however, differences in the tenacity of adhesive-binding are controlled by selecting or treating the polymer sheets such that their opposed surfaces exhibit a difference in surface energies. If the difference between the surface energies of the two surfaces is relatively large—at least 5 Dynes per centimeter (commonly referred to by the shorthand term “Dynes”)—then the adhesive will bind significantly more tenaciously to one surface than the other. As the difference in surface energies of the two surfaces increases beyond 5 Dynes per centimeter, the likelihood that all of the adhesive will remain with one sheet when the two sheets are separated increases. A difference of 5 to 14 Dynes per centimeter between the adhered surfaces of the two sheets is considered appropriate.

It may be possible to separate two surfaces having an adhesive interposed between them, even if the surface energies of the surfaces differ by less than 5 Dynes per centimeter. In this situation, the adhesive may adhere to each of the two surfaces with roughly equal tenacity, meaning that the adhesive may adhere to both surfaces (at various portions) after the two surfaces are separated from one another. In many applications, it is desirable to have most or all of the adhesive to adhere to the surface of only a single one of the polymer sheets (usually the one being peeled away from the remaining sheets or substrate). For such applications, the two surfaces contacted by the adhesive should preferably have surface energies that differ by at least 5 Dynes per centimeter.

The amount of force needed to separate laminated sheets from their underlying surface is not critical, but is preferably sufficiently small to prevent tearing and substantial stretching of the laminated sheet upon manual peeling of the sheet from the surface. The amount of separation force needed is a function of the materials selected for the laminated sheets, the underlying surface, and any barrier composition or adhesive interposed between them. Practically speaking, the tenacity of adhesion between a laminated sheet and the underlying surface should be selected so that the sheet can be peeled away from the surface using normal human strength, but not so tenacious that the sheet must be torn or punctured by a person peeling the sheet from the surface. A skilled artisan recognizes that the numerous variables (e.g., the angle at which the laminated sheet is pulled from the surface, whether fingernails are applied to the sheet surface, the speed with which the sheet is peeled, the temperature of the shaped article at the time of peeling) can affect the peeling characteristics of the sheet, and the materials described herein include all materials that are operable under the ambient conditions corresponding to anticipated uses of the materials and shaped articles.

To the extent that an objective measure of the force needed to peel a laminated sheet from an underlying substrate surface is desired, a standardized test of peel strength can be used. An example of a suitable test is ASTM D3330/D3330M, which is a standardized test for peel adhesion of pressure-sensitive tape. A modification of this procedure (e.g., substituting a sheet of the substrate material in place of the standard steel sheet in ASTM D3330/D3330M and selecting a peel angle appropriate for the intended use of the shaped article being tested) can also be used. In each case, the characteristics of the shaped article or stack should be selected such that the peel strength of the finished article is within the limits of human strength.

Various surface treatments and polymer sheet ingredients can be used to affect the surface energy.

In one embodiment of the stack and shaped articles described herein, multiple adjacent polymer sheets are made of the same material. Unless treated non-identically, the two faces of a polymer sheet will normally have the same surface energy. Therefore, in stacks and articles which include multiple identical polymer sheets, it is important that the two faces of the identical polymer sheets be treated differently, so as to yield a polymer sheet having different surface energy values for each of its two faces. Such sheets are preferably treated such that the surface energies of their faces differ by 5 Dynes per centimeter or more. Many compositions and methods for affecting the surface energy of polymer sheets are known to skilled artisans in this field, and substantially any of those methods may be employed. Such methods include conventional surface finishing techniques such as grinding and polishing, annealing processes, Corona treatment, and plasma contact techniques such as atmospheric, chemical, and flame plasma techniques. Compositions for affecting the surface energy of a surface of a polymer sheet are also well known, and include compounds that can be contacted or reacted with the surface to modify its chemical or physical properties (affecting its surface energy).

An example of a suitable surface treatment is the process known as Corona treatment or Corona discharge treatment, which involves application to a surface of a high-frequency, high voltage electrical discharge. Corona treatment raises the surface energy of a polymeric surface. Applied to one face of a polymer sheet having two otherwise identical faces, Corona treatment will raise the surface energy of the face, relative to the opposite face of the sheet. The power applied in a Corona treatment can be controlled to limit the treatment substantially to one side of a sheet. At very high power, the treatment can raise the surface energy of both faces of the same sheet which, in the absence of other surface treatments, will not yield a polymer sheet having different surface energies on its two faces. If a polymer sheet is Corona treated at or near the time it is formed, the surface energy-raising effects of the treatment can endure for weeks, months, or years. If the sheet is Corona treated days, weeks, or later after the sheet is made, the surface energy-raising effects of the treatment can be more transitory (e.g., enduring only for days or weeks). Polymer sheets that are Corona treated at or very near the time they are formed can be used in the stacks and articles described herein. Polymer sheets can also be “bump-treated” (i.e., be Corona treated regardless of how long it has been since the sheet was formed) shortly before making the stacks and articles described herein.

Printing

Text, images, or other graphical material can be printed onto one or more faces of one or more of the polymer sheets and layers described herein. A wide variety of materials and methods can be used to print such material onto the surface of a polymer sheet. A difficulty inherent in printing on polymer materials is that the printed matter can often easily be displaced from the polymer surface by heat, light, or mechanical abrasion, leading to reduced print quality. Furthermore, it can be undesirable for the materials used for printing to contact materials that will be in contact with the polymer. For example, it can be undesirable to have printing inks contact paint on the interior surface of a paint tray. These effects can be avoided by applying a clear polymer sheet or layer over top of the printed matter, thereby securing it in place and preventing its displacement. However, the clear layer often cannot be peeled off without severely damaging the printed matter and/or leaving portions of the printed matter on the peeled sheet and the underlying surface.

In one embodiment of the laminated sheets described herein, printed matter is incorporated onto one or more polymer layers or sheets (i.e., one or more of the proximal, medial, and distal sheets) of the laminated sheet is peelable coherently with the laminated sheet. The printed matter is printed on a surface other than the contact face of the laminated sheet, so that the printed matter does not contact whatever may touch the contact face of the laminated sheet. This is of particular importance when the contact face is intended to contact foodstuffs, medicines, or other articles or fluids that may be ingested by or inserted into the body of a human.

In many instances, it is desirable that the printed matter be visible by an observer observing the contact face of the laminated sheet. This can be achieved by using a clear polymer to form at least the distal-most layer of the distal sheet and applying or inserting the printed matter at a position on or within the laminated sheet that is located proximally relative to the contact face. By way of example, a laminated sheet having printed matter readable through the contact face can have such printed matter printed on the distal face of the medial layer, to which a clear distal layer is bound.

The tenacity of binding of printed matter to a polymer sheet or layer can, as described herein for adhesives, be affected by surface treatment of the polymer sheet prior to printing upon it. Corona treatment and plasma discharge techniques, for example, can raise the surface energy of a polymer surface, rendering it susceptible to more tenacious binding by the printed matter. Likewise, surface treatment (e.g., Corona treatment) of a polymer surface having printed matter thereon can raise the surface energy of the surface (including the portion on which the printed matter appears). By applying to the printed portion of the surface an adhesive that adheres more tenaciously to the printed portion than to the opposed underlying surface, adhesion of the adhesive with the printed matter can be maintained upon peeling of the sheet carrying the printed matter from the underlying surface.

Slip Compositions

The subject matter described herein includes stacks of laminated sheets in which the stacked laminated sheets adhere to one another (e.g., owing to an adhesive interposed between the stacked sheets). Such stacked sheets are often handled in rolls (e.g., spirally-wound rolls of multi-sheet stacks), piles of multi-sheet stacks, and the like. In order to inhibit undesired bonding between the outermost sheets of different stacks, one or more surfaces of the stack (e.g., the contact face of the distal-most laminates sheet) can be coated with a slip composition. Such slip compositions permit unwinding of rolls of stacked laminated sheets without inducing peeling or de-stacking of the laminated sheets.

The identity and composition of slip compositions interposed between polymer sheets used in the articles and methods described herein are not critical. A skilled artisan will recognize that substantially any material can be used as a slip composition between two polymers, so long as it substantially prevents fusion of two polymers under conditions at which at least one of the polymers can be thermoformed. A wide variety of such slip compositions are known for this purpose (e.g., see the publication “Slip & Antiblock Products” published by Wells Plastics, Ltd. of Stone, Staffordshire, UK).

Shaped Articles

Included in embodiments of this disclosure are shaped articles that include multiple, substantially identically-shaped, thermo formable laminated sheets that overlap at an overlapping region. By way of example, the shaped articles can have the form of a container that includes a substrate having a shaped side including an interior surface and at least one peelable laminated sheet including a bottom sheet. Each laminated sheet conforms to the shape of the shaped side, including substantially the entire interior surface, and has an adhesion surface and a contact surface. The adhesion surface of each laminated sheet other than the bottom sheet is releasibly adhered to the contact surface of the underlying laminated sheet with a peelable adhesive on substantially the entire portion of the adhesion surface that overlaps the interior surface. The adhesion surface of the bottom sheet is releasibly adhered to the shaped side with a peelable adhesive on substantially the entire portion of the bottom sheet that overlaps the interior surface.

In another embodiment, this disclosure relates to a shaped article that includes a shaped thermoformable polymer sheet. A plurality of laminated sheets overlap the thermoformable sheet at an overlapping region and conform to the shape of the thermoformable sheet at substantially the entire overlapping region. A first barrier composition is interposed between and peelably adheres the thermoformable sheet and the adjacent laminated sheet. A second barrier composition is interposed between and peelably adheres adjacent laminated sheets. The laminated sheets are peelably removable from the article.

Thermoforming Apparatus and Conditions

The articles described herein can be made using known thermoforming apparatus and conditions. Of course, the apparatus and conditions should be selected based on the identity and the characteristics of the materials to be processed. Selection of appropriate thermoforming conditions, based on the identity(ies) of the materials to be processed is within the ken of a skilled artisan in this field.

In one example of thermoforming known as vacuum molding, a sheet is positioned adjacent a female (or male) mold section and a vacuum is applied to draw the sheet against the mold surface. A male mold section may be pressed against the sheet on the opposite side of the sheet from the female mold section to assist in conforming the sheet to the shape of the female mold section. In other processes, such as pressure forming, the heated sheet is pressed against a male mold section (or, more frequently, into a female mold section), usually with the assistance of a vacuum to conform the sheet to the mold shape.

In another embodiment, the face of a clinging sheet (i.e., a plastic sheet capable of clinging to one or both of the laminated sheet described herein and a thermoformed or thermoformable substrate sheet against which the laminated sheet overlaps) abuts a face of the laminated sheet, such as the adhesion face of the distal sheet. The interposed clinging sheet can be made from any known materials used to make clinging, peelably removable sheets, such as polymer sheets made from, including, or faced with one or more of LLDPE or a PVC. They may also have a commercial cling agent of the type used in known clinging, peelably removable sheets. If the face of the laminated sheet against which the clinging sheet abuts has printing thereon, the clinging sheet can prevent transfer of printed ink or print substrate through the clinging sheet.

The disclosure of every patent, patent application, and publication cited herein is hereby incorporated herein by reference in its entirety.

While the subject matter has been disclosed herein with reference to specific embodiments, it is apparent that other embodiments and variations of this subject matter can be devised by others skilled in the art without departing from the true spirit and scope of the subject matter. The appended claims include all such embodiments and equivalent variations.

What is claimed is:

1. A laminated sheet suitable for use as a peelable liner on a thermoformed article for contacting an oily or aqueous liquid, the laminated sheet having a contact face and an adhesion face opposite the contact face and comprising at least medial and distal polymer sheets,
the medial sheet comprising a barrier layer of an odor-resistant polymer and having a proximal face and a distal face;
the distal sheet
comprising an anti-permeation polymer layer that substantially inhibits short-term permeation of the liquid therethrough,
bearing the contact face and having a first face opposite the contact face, and
having its first face bound to the distal face of the medial sheet by way of a first tie layer;
the contact face having a substantially lower surface energy than the adhesion face; and
the laminated sheet having flexibility and tensile strength sufficient to enable the laminated sheet to be peeled from a surface to which it is releasibly adhered without tearing.

2. The laminated sheet of claim 1, wherein the medial sheet is a single homopolymeric sheet.

3. The laminated sheet of claim 1, wherein the medial sheet comprises a layer of the odor-resistant polymer and a distal bonding layer at the distal face of the medial sheet.

4. The laminated sheet of claim 1, wherein the medial sheet comprises a layer of the odor-resistant polymer and a proximal bonding layer at the proximal face of the medial sheet.

5. The laminated sheet of claim 4, wherein the proximal face of the medial sheet is the adhesive face of the laminated sheet.

6. The laminated sheet of claim 1, wherein the odor-resistant polymer is selected from the group consisting of polyvinyl acetates (PVAs), polyvinyl alcohols (PVOHs), co-polymers of PVAs and polyolefins, co-polymers of PVOHs and polyolefins, polyamides, polyvinyl chlorides (PVCs), polyvinylidene chlorides (PVDCs), aromatic polyesters, and combinations of these.

7. The laminated sheet of claim 1, wherein the odor-resistant polymer is a polyamide selected from the group consisting of nylons, aramids, and combinations of these.

8. The laminated sheet of claim 1, wherein the odor-resistant polymer is a polyethylene terephthalate (PET).

9. The laminated sheet of claim 1, wherein neither the distal sheet nor the medial sheet comprises an oriented polymer layer.

10. The laminated sheet of claim 1, wherein the liquid is an aqueous liquid and the odor-resistant polymer is hygroscopic.

11. The laminated sheet of claim 1, wherein the distal sheet comprises a scratch-resistant polymer layer at the contact face of the laminated sheet.

12. The laminated sheet of claim 11, wherein the scratch-resistant polymer layer comprises an polymer selected from the group consisting of aromatic polyesters, polyacrylates, polyamides, polyurethanes, biaxially-oriented PETS, and combinations of these.

13. The laminated sheet of claim 1, wherein the first tie layer is a monolayer covalently bound to at least one of the distal sheet and the medial sheet.

14. The laminated sheet of claim 1, wherein the first tie layer is a monolayer covalently bound to both the distal sheet and the medial sheet.

15. The laminated sheet of claim 1, wherein the compositions and dimensions of the distal sheet and the tie layer are selected such that, following application of the liquid to the contact face at a pressure of six inches of the liquid for four hours, the concentration of the liquid in the barrier layer is less than 50% of the saturated concentration of the liquid in the odor-resistant polymer.

16. The laminated sheet of claim 1, wherein the thickness of the distal sheet is not greater than 6 mils.

17. The laminated sheet of claim 1, further comprising a proximal sheet, the proximal sheet
comprising a pliable polymer layer,
having a second face, and
having its second face bound to the proximal face of the medial sheet by way of a second tie layer.

18. The laminated sheet of claim 1, wherein the surface energy of the contact face is at least 5 Dynes per centimeter lower than the surface energy of the adhesion face.

19. The laminated sheet of claim 1, comprising a thermoformable polymer layer, wherein the rigidity of the laminated sheet is sufficient that the laminated sheet retains its thermoformed shape following thermoforming.

20. The laminated sheet of claim 1, further comprising a peelable adhesive coating at least a portion of the adhesion face thereof.

21. The laminated sheet of claim 20, wherein the tenacity with which the laminated sheet adheres to the substrate is substantially less than the tenacity with which the distal sheet is bound to the medial sheet.

22. A formable sheet comprising a sheet of a formable substrate having a first laminated sheet of claim 1 layered thereon and having a first barrier composition interposed therebetween.

23. The formable sheet of claim 22, comprising a plurality of additional laminated sheets layered on the formable substrate, wherein the additional laminated sheets are stacked substantially atop one another and substantially atop the first laminated sheet.

24. A shaped article having a peelable surface, made by thermoforming the formable sheet of claim 41.

25. A thermoformable stack comprising
a thermoformable polymeric substrate;
the laminated sheet of claim 1 overlapping the substrate at an overlapping region; and
a layer of a first barrier composition that prevents fusion of the surfaces of the substrate and the laminated sheet at the thermoforming condition, the barrier composition being interposed between faces of the substrate and the laminated sheet in a portion of the overlapping region,
whereby when the stack is subjected to the thermoforming condition, the substrate assumes a thermoformed shape and the laminated sheet conforms to that shape at the overlapping region, the substrate and the laminated sheet do not fuse in the portion of the overlapping region, and the laminated sheet can be peeled from the substrate at the portion following thermoforming.

26. A container comprising:
a) a substrate having a shaped side including an interior surface; and
b) at least one peelable liner sheet including a bottom sheet,
wherein each liner sheet conforms to the shape of the shaped side, including substantially the entire interior surface, and having an adhesion surface and a contact surface;
wherein the adhesion surface of each liner sheet other than the bottom sheet is releasibly adhered to the contact surface of the underlying liner sheet with a peelable adhesive on substantially the entire portion of the adhesion surface that overlaps the interior surface;
wherein the adhesion surface of the bottom sheet is releasibly adhered to the shaped side with a peelable adhesive on substantially the entire portion of the bottom sheet that overlaps the interior surface; and
wherein each liner sheet is a laminated sheet of claim 1.

27. A shaped article comprising
a shaped thermoformable polymer sheet;
a plurality of laminated sheets that overlap the thermoformable sheet at an overlapping region and conform to the shape of the thermoformable sheet at substantially the entire overlapping region;
a first barrier composition interposed between and peelably adhering the thermoformable sheet and the adjacent laminated sheet;
and a second barrier composition interposed between and peelably adhering adjacent laminated sheets,
the laminated sheets being peelably removable from the article,
wherein each laminated sheet is a laminated sheet of claim 1.
